(19) United States
(12) Patent Application Publication
(10) Pub. No.: US 2026/0332654 A1
(43) Pub. Date: Oct. 22, 2026

(54) USER-AUTHORIZED CRYPTOGRAPHIC AND RELATIONAL CONSISTENCY VERIFICATION FOR SECURE COMMUNICATIONS

(71) Applicant: ICA AI, Inc., Boca Raton, FL (US)

(72) Inventors: Raymond J. Sheppard, Spring Hill, FL (US); Ruchi Singh, Bangalore (IN)

(21) Appl. No.: 19/717,660

(22) Filed: Jun. 24, 2026

Related U.S. Application Data
(63) Continuation-in-part of application No. 19/547,701, filed on Feb. 24, 2026.
Application No. 19/547,701 is a continuation-in-part of application No. 19/546,455, filed on Feb. 23, 2026.
Application No. 19/546,455 is a continuation-in-part of application No. 19/350,012, filed on Oct. 5, 2025, now Pat. No. 12,621,354.
Application No. 19/350,012 is a continuation-in-part of application No. 19/298,256, filed on Aug. 13, 2025, now Pat. No. 12,621,353.
Application No. 19/298,256 is a continuation-in-part of application No. 19/224,748, filed on May 31, 2025, now Pat. No. 12,457,255.
Application No. 19/224,748 is a continuation-in-part of application No. 19/066,192, filed on Feb. 28, 2025, now Pat. No. 12,388,880.
Application No. 19/066,192 is a continuation-in-part of application No. 18/921,443, filed on Oct. 21, 2024, now Pat. No. 12,261,893.
Application No. 18/921,443 is a continuation of application No. 18/751,905, filed on Jun. 24, 2024, now Pat. No. 12,155,700.
(60) Provisional application No. 63/601,645, filed on Nov. 21, 2023.

(51) Int. Cl. H04L 65/1076; H04L 51/02; H04L 65/1096

(52) U.S. Cl. CPC H04L 65/1076; H04L 51/02; H04L 65/1096

(57) ABSTRACT

A system and method for secure communication between autonomous artificial intelligence agents are disclosed. A trusted client application receives a voice command for an AI agent to process communication and performs biometric identity verification. Upon successful verification, the system produces a biometric authorization signal and biometric attestation, generates an intent token including recipient, intent, metadata, expiry timestamp, and nonce, and uses the biometric authorization signal to gate signing of the intent token by a private key stored in a hardware security module. The trusted client application transmits the signed intent token and biometric attestation to a centralized trust verification server for cryptographic verification and relational consistency verification based on sender-recipient relationship fingerprints. Upon successful verification, the AI agent transmits an AI-mediated communication with the signed intent token and biometric attestation. A receiving verification node performs pre-delivery verification and routes the communication for direct delivery, screened delivery, or block delivery.

### CROSS-REFERENCE TO RELATED APPLICATIONS

This application is a continuation-in-part of U.S. patent application Ser. No. 19/547,701, filed Feb. 24, 2026, which is a continuation-in-part of U.S. patent application Ser. No. 19/546,455, filed Feb. 23, 2026, now U.S. Pat. No. 12,621,354, which is a continuation-in-part of U.S. patent application Ser. No. 19/350,012, filed Oct. 5, 2025, now U.S. Pat. No. 12,621,353, which is a continuation-in-part of U.S. patent application Ser. No. 19/298,256, filed Aug. 13, 2025, now U.S. Pat. No. 12,457,255, which is a continuation-in-part of U.S. patent application Ser. No. 19/224,748, filed May 31, 2025, now U.S. Pat. No. 12,388,880, which is a continuation-in-part of U.S. patent application Ser. No. 19/066,192, filed Feb. 28, 2025, now U.S. Pat. No. 12,261,893, which is a continuation-in-part of U.S. patent application Ser. No. 18/921,443, filed Oct. 21, 2024, now U.S. Pat. No. 12,155,700, which is a continuation of U.S. patent application Ser. No. 18/751,905, filed Jun. 24, 2024, which claims the benefit of U.S. Provisional Patent Application No. 63/601,645, filed Nov. 21, 2023, the disclosures of which are hereby incorporated by reference in their entireties.

### BACKGROUND OF THE INVENTION

### Field of the Art

The disclosure relates to the field of communications, and more particularly to the field of securing communications between autonomous artificial intelligence (AI) agents via user authorized cryptographic and relational consistency verifications.

### Discussion of the State of the Art

Current communication security systems face increasing challenges in the modern artificial intelligence (AI) era. The deployment of autonomous AI agents as communication initiators introduces various threats that the current communication architecture cannot address. For example, an unregistered AI agent may be deployed for spam, fraud, or other malicious purposes. Another example may be a sleeper attack, where an autonomous agent that has been compromised through prompt injection, malicious skill installation, supply chain attack, or any other mechanism, executes communication without owner's authorization while carrying owner's valid credentials.

Conventional authentication systems verify entities by validating credentials and hence are insufficient to detect whether the agent behind that identity has been compromised. As a compromised AI agent holds valid credentials, it passes authentication because the credentials remain legitimate despite the AI agent being compromised. For example, STIR/SHAKEN confirms a calling number belongs to a legitimate carrier, Branded Caller ID confirms a calling organization's identity. These systems are limited by their narrow scope and structure, which remain susceptible to manipulation by sophisticated threat actors.

Hence, there is a need for a new approach to communication security that can protect users from evolved AI-powered threats without relying only on identity verifications, such as compromised legitimate agents.

### SUMMARY OF THE INVENTION

Accordingly, the inventor has conceived and reduced to practice, in a preferred embodiment of the invention, a system for secure communications between autonomous artificial intelligence (AI) agents via user authorized cryptographic and relational consistency verifications. The system receives a voice command from a user of a computing device for an AI agent associated with the computing device to process a communication, analyzes the voice command for identity confirmation of the user based on a registered voice biometric profile, and is responsive to successful identity confirmation, produces a biometric authorization signal and a biometric attestation. The system generates an intent token comprising an intent data structure based on the voice command, wherein the intent data structure comprises information of a recipient, an intent of the communication, metadata of the voice command, an expiry timestamp and a nonce. Upon receipt of the biometric authorization signal, the system performs a signing operation of the intent token using a private key to produce a signed intent token, wherein the private key is generated and stored within the hardware security module, and is inaccessible to a software process, operating system, application, or AI agent running on the computing device or on a remote system.

According to a preferred embodiment of the invention, the system shares the signed intent token and the biometric attestation with a centralized trust verification server for cryptographic verification, and relational consistency verification based on the intent of the communication. The cryptographic verification validates the signed intent token's signature, the agent's identity and registration, and the integrity of the agent's instruction set. The relational consistency verification analyzes the intent of the communication based on relationship fingerprints including behavioral models derived from metadata of historical communications between the sender and the recipient and computes a multi-attribute behavioral consistency score. Responsive to successful cryptographic verification and relational consistency verification, the AI agent transmits an AI-mediated communication based on the intent data structure, along with the signed intent token and the biometric attestation towards a recipient computing device.

Before delivering the AI-mediated communication to the recipient, a receiving verification node at a network infrastructure performs the cryptographic verification and the relational consistency verification and routes the AI-mediated communication based on a routing decision comprising a direct delivery, a screened delivery, or a block delivery to the recipient. The system operates bidirectionally; each registered user's computing device is capable of both authorizing outbound AI agent communications through biometric verification and hardware-bound intent token signing, and verifying inbound AI agent communications through the receiving verification node creating a symmetric trust architecture.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary architectural arrangement of clients, servers, and external services, according to an embodiment of the invention.

FIG. 3 is a block diagram depicting a typical exemplary architecture of one or more embodiments or components thereof on a standalone computing system.

FIG. 4 is a block diagram illustrating an exemplary computing system suitable for implementing artificial intelligence and machine learning workloads, according to an embodiment of the invention.

FIG. 5 is an example of a communication system for secure communication between autonomous artificial intelligence (AI) agents, according to an embodiment of the invention.

FIGS. 6A and 6B depict user interfaces of a trusted client application on a user device, showing an outbound interface and an inbound interface respectively, according to an embodiment of the invention.

FIG. 7 is a flow diagram of an example method for secure communication between autonomous AI agents of computing devices, according to an embodiment of the invention.

FIG. 8 is a flow diagram of an example method for performing cryptographic verification of a signed intent token, according to an embodiment of the invention.

FIG. 9 is a flow diagram of an example method for performing relational consistency verification, according to an embodiment of the invention.

FIG. 10 is a flow diagram of an example method for routing AI-mediated communications, according to an embodiment of the invention.

FIG. 11 is an interaction sequence diagram illustrating the temporal flow of messages and data between system components during a secure AI agent communication session, according to an embodiment of the invention.

### DETAILED DESCRIPTION

The inventors have conceived, and reduced to practice, a system for secure communication between artificial intelligence (AI) agents via user-authorized cryptographic and relational consistency verifications. Unlike existing authentication systems that verify entity identity or behavioral patterns, the present invention provides integration of cryptographic verification of human authorization with relational consistency verification before an AI agent initiates communication with another AI agent. Human authorization is performed by a hardware-bound, biometrically authenticated cryptographic intent token for every agent-initiated communication. In addition, communication may be evaluated against established relationship fingerprints of the communicating parties. This approach provides a unique trust determination gate that automatically strengthens as the relationship develops and pattern knowledge grows. In summary, the present invention requires both cryptographic proof that a specific human authorized a specific communication at this specific moment through biometric-gated hardware-bound signing, and relational behavioral evidence that the communication is consistent with the established relationship between the communicating parties before the AI agent is permitted to transmit the AI-mediated communication towards the recipient.

Furthermore, the system operates bidirectionally, with each user's device capable of both authorizing outbound agent's communications through cryptographic signing and verifying inbound agent's communications through a receiving verification node before delivery. Verification occurs in two phases: a pre-initiation verification of the communication before transmitting the communication from a computing device, and a pre-delivery verification of the communication before delivering the communication to the recipient. Accordingly, the system enables authorizing outbound communications through pre-initiation verification including biometric verification and hardware-bound intent token signing, and verifying inbound communications through a pre-delivery verification, and creating a symmetric trust architecture in which the same trust determination process applies to communications in either direction.

One or more different inventions may be described in the present application. Further, for one or more of the inventions described herein, numerous alternative embodiments may be described; it should be appreciated that these are presented for illustrative purposes only and are not limiting the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. On the contrary, a variety of optional components may be described to illustrate a wide variety of possible embodiments of one or more of the inventions and in order to fully illustrate one or more aspects of the inventions. Similarly, although process steps, method steps, algorithms or the like may be described in sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of the described processes may be performed in any practical order. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the inventions, and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of more than one device or article.

The functionality or features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code that include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

As used herein, the terms “module,” “component,” “engine,” and “unit” refer to hardware, software, firmware, or combinations thereof configured to perform a specified function. A module may be implemented as a dedicated hardware circuit, as software executing on a general-purpose processor, as firmware stored in non-volatile memory, or as any combination thereof. Multiple modules may be combined into a single component, or a single module may be distributed across multiple components, as appropriate for a particular implementation.

As used herein, “real-time” refers to processing that occurs with sufficiently low latency that results are available for their intended use without perceptible delay to a user or within the time constraints of the system's operational requirements. Real-time processing may include latencies ranging from sub-millisecond for control systems, milliseconds for interactive applications, to seconds for batch processing, depending on the operational context and requirements of the specific embodiment.

As used herein, “network” refers broadly to any computational architecture comprising interconnected layers of nodes (neurons) with learnable weights and activation functions, including without limitation feedforward neural networks, convolutional neural networks (CNNs), recurrent neural networks (RNNs), long short-term memory (LSTM) networks, transformer-based models, graph neural networks, and hybrid architectures combining elements thereof.

### Hardware Architecture

In certain implementations, the disclosed technology can be implemented using a parallel processing architecture that includes one or more accelerator devices configured to perform matrix and tensor operations for machine learning workloads. The accelerator devices can be realized using graphics processing units (GPUs), tensor processing units (TPUs), application-specific integrated circuits (ASICs), neural processing units (NPUs), field-programmable gate arrays (FPGAs), or other specialized compute units, and can be interconnected with host processors and memory subsystems via high-bandwidth interconnects to facilitate efficient training and inference of large-scale neural networks and other data-parallel workloads.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

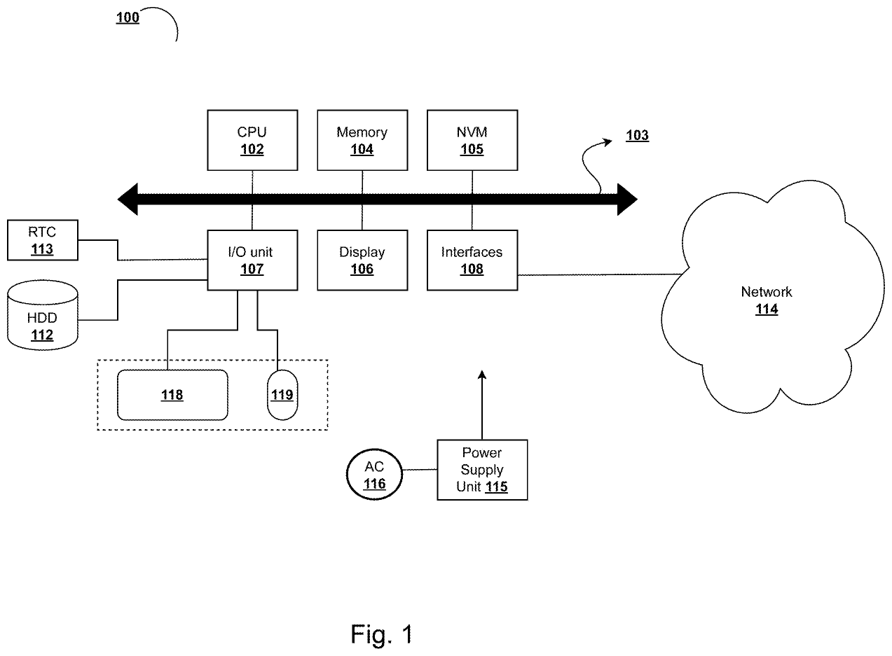

Referring now to FIG. 1, there is shown a block diagram depicting an exemplary computing device 100 suitable for implementing at least a portion of the features or functionalities disclosed herein. Computing device 100 may be, for example, any one of electronic devices capable of executing software- or hardware-based instructions according to one or more programs stored in memory. Computing device 100 may be adapted to communicate with a plurality of other computing devices, such as clients or servers, over communications networks, such as a wide area network, a metropolitan area network, a local area network, a wireless network, the Internet, or any other network, using known protocols for such communication, whether wireless or wired.

Computing device 100 includes a central processing unit (CPU) 102 connected to bus 103. Several key components including memory 104, non-volatile memory (NVM) 105, display 106, I/O unit 107, and interfaces 108 are also connected to bus 103.

Interfaces 108 are designed to connect to a network 114, which may be the Internet or a local network, which local network may or may not have connections to the Internet. Also shown as part of computing device 100 is power supply unit 115 connected, in this example, to AC supply 116.

I/O unit 107 may be connected to peripheral devices such as keyboard 118, pointing device 110, hard disk 112, and real-time clock (RTC) 113. Input devices may be of any type suitable for receiving user input, including for example a keyboard 118, touchscreen, microphone (for example, for voice input), mouse 119, touchpad, trackball, or any combination thereof. Output devices may be of any type suitable for providing output to one or more users and may include for example one or more screens for visual output, speakers, printers, or any combination thereof.

Memory 104 may be random-access memory having any structure and architecture known in the art, for use by processors, for example to run software. In a specific embodiment, memory 104 (such as non-volatile random-access memory (RAM) and/or read-only memory (ROM), including for example one or more levels of cached memory) may also form part of CPU 102. However, there are many different ways in which memory 104 may be coupled to computing device 100. Memory 104 may be used for a variety of purposes such as, for example, caching and/or storing data, programming instructions, and the like.

When acting under the control of appropriate software or firmware, CPU 102 may be responsible for implementing specific functions associated with the functions of a specifically configured computing device or machine. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors such as, for example, a processor from one of the Intel®, ARM®, Qualcomm®, and AM® families of microprocessors. In some embodiments, processors may include specially designed hardware such as application-specific integrated circuits (ASICs), electrically erasable programmable read-only memories (EEPROMs), field-programmable gate arrays (FPGAs), and so forth, for controlling operations of computing device 100. It should be further appreciated that CPU 102 may be one of a variety of system-on-a-chip (SOC) type hardware that may include additional hardware such as memory or graphics processing chips, such as a Qualcomm® SNAPDRAGON™ or Samsung® EXYNOS™ CPU or AMD® Ryzen™ processor or Intel® Xeon™ processor, Apple® Silicon (M-series) or others as are becoming increasingly common in the art, such as for use in mobile devices or integrated devices. As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit. Processors may carry out computing instructions under control of an operating system such as, for example, a version of Microsoft's® WINDOWS™ operating system, Apple's® Mac OS/X or Apple's® iOS™ operating systems, some variety of the Linux operating system, Google's ANDROID™ operating system, or the like stored in memory.

In one embodiment, interfaces 108 enable wired or wireless communication between computing device 100 and network 114. Interfaces 108 are provided as network interface cards (NICs). Generally, NICs control the sending and receiving of data packets over a computer network; other types of interfaces 108 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB®), Serial, Ethernet®, FIREWIRE™, THUNDERBOLT™, PCIe®, parallel, radio frequency (RF), BLUETOOTH™, near-field communications (e.g., using near-field magnetics), 802.11 (Wi-Fi™), frame relay, TCP/IP, ISDN, fast Ethernet interfaces, Gigabit Ethernet interfaces, Serial ATA (SATA®) or external SATA (ESATA®) interfaces, high-definition multimedia interface (HDMI®), digital visual interface (DVI®), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 108 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors may be used, and such processors may be present in a single device or distributed among any number of devices. In one embodiment, a single processor handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the computing device of the present invention may employ one or more memories or memory modules (such as, for example, remote memory step and local memory) configured to store data, program instructions for the general-purpose network operations, or other information relating to the functionality of the embodiments described herein (or any combinations of the above). Program instructions may control execution of or comprise an operating system and/or one or more applications, for example. Memory 104 may also be configured to store operating systems, data structures, configuration data, encryption data, historical system operations information, or any other specific or generic non-program information described herein. Because such information and program instructions may be employed to implement one or more systems or methods described herein, at least some network device embodiments may include non-transitory machine-readable storage media, which, for example, may be configured or designed to store program instructions, state information, and the like for performing various operations described herein. Various embodiments may be implemented as one or more non-transitory computer-readable media storing instructions that, when executed by one or more processors, cause the one or more processors to perform the methods and operations described herein. The instructions may be stored as software, firmware, microcode, or any other form of machine-executable instructions.

Examples of such non-transitory machine-readable storage media include, but are not limited to, magnetic media such as hard disks 112, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

Computing device 100 includes processors that may run software that carry out one or more functions or applications of embodiments of the invention, such as for example a client application. In many cases, one or more shared services may be operable in computing device 100 and may be useful for providing common services to client applications. Services may for example be WINDOWS™ services, user-space common services in a Linux environment, or any other type of common service architecture used with operating system.

Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

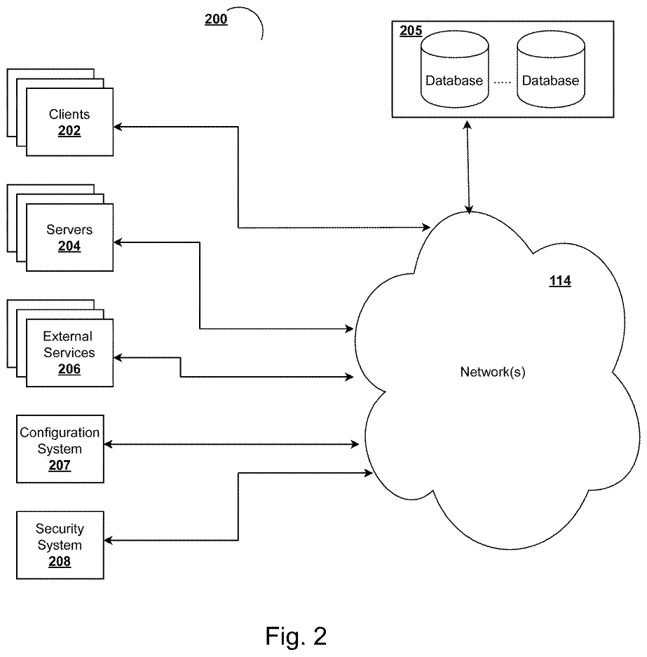

In some embodiments, systems of the present invention may be implemented on a distributed computing network, such as one having any number of clients and/or servers. Referring now to FIG. 2, there is shown a block diagram depicting an exemplary architecture 200 for implementing at least a portion of a system according to an embodiment of the invention on a distributed computing network. According to the embodiment, any number of clients 202 may be provided. Each client 202 may run software for implementing client-side portions of the present invention; clients may comprise a system such as that illustrated in FIG. 1. In addition, any number of servers 204 may be provided for handling requests received from one or more clients 202. Clients 202 and servers 204 may communicate with one another via one or more electronic networks 114, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 114 may be implemented using any known network protocols, including for example wired and/or wireless protocols.

In addition, in some embodiments, servers 204 may call external services 206 when needed to obtain additional information, or to refer to additional data concerning a particular incoming communication. Communications with external services 206 may take place, for example, via one or more networks 114. In various embodiments, external services 206 may comprise web-enabled services or functionality related to or installed on the hardware device itself. For example, in an embodiment where client applications are implemented on a smartphone or other electronic device, client applications may obtain information stored in server system 204 in the cloud or on an external service 206 deployed on one or more of a particular enterprise or user's premises.

In some embodiments of the invention, clients 202 or servers 204 (or both) may make use of one or more specialized services or appliances that may be deployed locally or remotely across one or more networks 114. For example, one or more databases 205 may be used or referred to by one or more embodiments of the invention. It should be understood by one having ordinary skill in the art that databases 205 may be arranged in a wide variety of architectures and using a wide variety of data access and manipulation means. For example, in various embodiments, one or more databases 205 may comprise a relational database system using a structured query language (SQL), while others may comprise an alternative data storage technology such as those referred to in the art as “NoSQL” (for example, Apache® Hadoop®, Google® BigTable®, MongoDB®, and others. In some embodiments, variant database architectures such as column-oriented databases, in-memory databases, clustered databases, distributed databases, or even flat file data repositories may be used according to the invention. In addition, Graph-oriented databases, also known as graph databases, are designed to manage and store data structured as graphs, where entities (nodes) are interconnected with relationships (edges), “examples include Amazon® Neptune®, Microsoft® Azure® Cosmos DB®, TigerGraph®, and others. These databases are particularly effective for applications involving complex relational queries and traversals, such as social networks, recommendation systems, and network topology analysis.

In addition, vector databases also referred to as vector search databases or similarity search databases, are engineered to index, manage, and retrieve high-dimensional vectors typically generated by machine learning models. These databases are adept at handling operations such as nearest neighbor search in vector space, which is critical for tasks involving image recognition, natural language processing, and recommendation engines, where items are represented as vectors in a multi-dimensional space. Notable examples include Pinecone, Milvus, Weaviate, and Elasticsearch® with vector plugins. Vector databases excel in scenarios that require matching patterns or finding similar items based on vector proximity, making them indispensable for modern AI-driven applications such as semantic search, personalization features, and fraud detection systems.

In various embodiments, the distributed system may include load balancers for distributing traffic across servers 204, API gateways for managing client requests, and service mesh components for inter-service communication.

It will be appreciated by one having ordinary skill in the art that any combination of known or future database technologies may be used as appropriate unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, most embodiments of the invention may make use of one or more security systems 208 and configuration systems 207. Security and configuration management are common information technology (IT) and web functions, and some amount of each is generally associated with any IT or web systems. It should be understood by one having ordinary skill in the art that any configuration or security subsystems known in the art now or in the future may be used in conjunction with embodiments of the invention without limitation unless a specific security system 208 or configuration system 207 or approach is specifically required by the description of any specific embodiment.

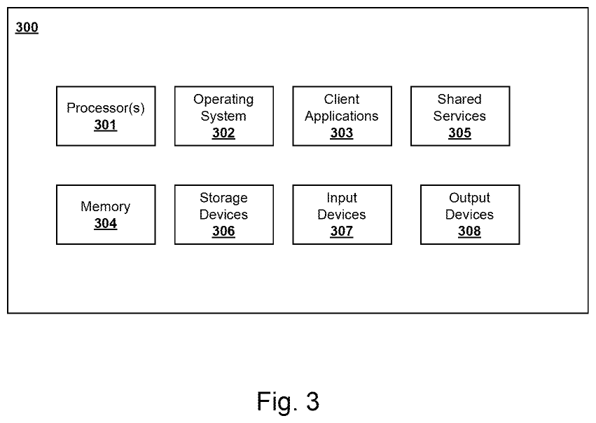

In some embodiments, the invention may be implemented on a standalone computing system 300 (as shown in FIG. 3). Computing device 300 includes processors 301 executing under control of operating system 302.

Operating system 302 provides the runtime environment for applications executing on computing device 300. Operating system 302 may comprise, for example, a version of Microsoft's WINDOWS™ operating system, Apple's macOS or iOS operating systems, a distribution of the Linux operating system (such as Ubuntu, Red Hat, or Debian), Google's ANDROID™ operating system, a real-time operating system (RTOS) for embedded applications, or other operating systems appropriate for the target platform. Operating system 302 manages hardware resources, provides system services, enforces security policies, and presents application programming interfaces (APIs) through which applications access system functionality. In embedded embodiments, operating system 302 may comprise a lightweight or minimal operating system optimized for the specific application requirements.

Client applications 303 implement the functionality of the invention, utilizing memory 304 for runtime data and storage devices 306 for persistent storage. Client applications 303 comprise one or more software applications implementing the functionality of embodiments of the invention. Client applications 303 execute in user space under control of operating system 302 and may interact with hardware resources through operating system APIs and device drivers.

Shared services 305 provide common functionality to applications 303. Input devices 307 and output devices 308 enable user interaction. Shared services 305 comprise software services providing common functionality to multiple client applications 303. Shared services 305 may include, for example, operating system services (such as WINDOWS™ services or Linux daemons), database engines providing local data storage and query capabilities, message queuing services for inter-process communication, logging and monitoring services, authentication and credential management services, and other middleware components. By implementing common functionality as shared services 305, computing device 300 reduces code duplication, ensures consistent behavior across applications, and enables efficient resource utilization. Shared services 305 may execute as background processes managed by operating system 302 and may be started automatically during system boot or on-demand when required by client applications 303.

In operation, computing device 300 boots operating system 302 from storage devices 306 into memory 304, initializes shared services 305, and launches client applications 303 either automatically or in response to user input via input devices 307. Client applications 303 process data, interact with users through input devices 307 and output devices 308, utilize shared services 305 for common functionality, and persist data to storage devices 306 as needed. The standalone architecture of computing device 300 enables operation without network connectivity, providing advantages including reduced latency, enhanced privacy, improved reliability in disconnected environments, and independence from external service availability.

Computing device 300 may include additional hardware components as described with reference to computing device 100 in FIG. 1, including but not limited to buses connecting system components, network interfaces for optional connectivity, power management circuitry, and specialized hardware accelerators. The software architecture illustrated in FIG. 3 may execute on any hardware platform providing the necessary computational resources, including personal computers, laptops, tablets, smartphones, embedded systems, industrial controllers, kiosk systems, point-of-sale terminals, medical devices, or other standalone computing platforms.

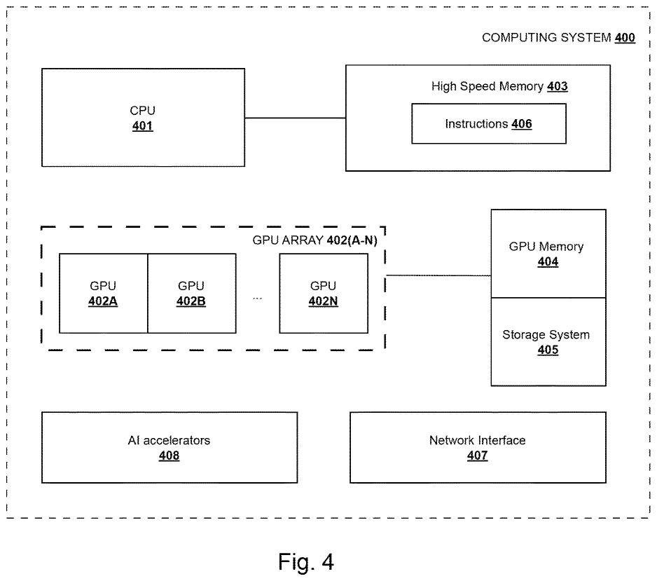

FIG. 4 is a block diagram of a computing system 400 with integrated Graphics Processing Units (GPU) array and hardware accelerators, according to an embodiment of the invention. Computing system 400 includes a CPU 401 connected to high-speed memory 403 that contains instructions 406 for execution. Computing system 400 may further include Graphics Processing Unit (GPU) Array 402(A-N), high-speed memory 403, GPU memory 404, storage system 405, network interface 407, and hardware accelerators 408. The hardware architecture illustrated in FIG. 4 represents an optimized configuration for intensive computational operations characteristic of modern artificial intelligence and machine learning systems. The combination of multi-core CPU 401 for workflow orchestration, large High-Speed Memory 403 for maintaining active datasets, powerful GPU Array 402(A-N) for parallel computations, optional accelerators 408 for specialized operations, high-bandwidth Network Interface 407 for external communications, and purpose-built instructions 406 create a system specifically designed to execute computationally intensive operations efficiently.

This architecture enables the system to process large datasets, perform millions of computational operations in parallel, execute complex neural network models, and achieve high throughput while maintaining practical processing times that would be impractical with conventional computing infrastructure. Computing system 400 may be configured for model training, model inference, or both. Training configurations typically require larger memory capacity and higher computational throughput, while inference configurations may prioritize latency and power efficiency

In various embodiments, neural network models may be quantized to reduced precision formats (INT8, INT4, FP16, BF16) to increase throughput and reduce memory requirements while maintaining acceptable accuracy for inference tasks.

Central Processing Unit (CPU) 401 comprises one or more high-performance processors with multi-core architecture configured to orchestrate communication between system components and manage overall workflow execution. CPU 401 executes control logic, handles API communications with external services, manages iterative processing loops, and performs sequential operations including data parsing, database queries, and coordination tasks. CPU 401 maintains bidirectional communication with high-speed memory 403 for rapid data access and with accelerator hardware for computational offloading. In preferred embodiments, CPU 401 comprises server-grade processors with 8 to 128 cores operating at frequencies between 2.0 GHz and 5.0 GHz, providing the processing power necessary for managing concurrent operations across system components.

High-Speed Memory 403 comprises high-bandwidth random access memory (RAM) configured to store intermediate data structures, active model parameters, and working datasets during processing operations. High-speed memory 403 maintains loaded neural network model weights, active database portions, vectorized representations, intermediate computation results, and temporary data structures. Within High-Speed Memory 403 resides instructions 406, which comprise the executable software implementing the computational methodology described in this invention. In preferred embodiments, high-speed memory 403 comprises at least 32 GB to 512 GB of DDR4, DDR5, or HBM memory operating at speeds exceeding 3200 MHz to support rapid data access patterns required by the computational algorithms, with larger deployments utilizing up to 2 TB of memory for processing large-scale datasets.

GPU Array 402(A-N) comprises one or more graphics processing units or specialized tensor processing units configured to accelerate parallel computational operations inherent in machine learning and artificial intelligence systems. GPU Array 402(A-N) includes GPU 402A, GPU 402B, through GPU 402N, where N may range from 1 to 16 or more GPUs in distributed configurations. The array dramatically accelerates operations including matrix multiplications, convolution operations, transformer model inference, embedding generation, attention mechanisms, vector similarity computations, and other parallelizable operations common to neural network architectures. The GPUs communicate with CPU 401 via high-speed PCIe® 4.0, PCIe® 5.0, or Compute Express Link (CXL)™ interconnects and with each other via NVIDIA® NVLink™, NVIDIA® NVSwitch™, AMD® Infinity Fabric™, or similar GPU-to-GPU communication protocols, enabling efficient multi-GPU parallelization of large batch operations. Each GPU in the array processes different data batches simultaneously, allowing the system to handle high-throughput computational workloads. GPU Array 402(A-N) maintains bidirectional communication with GPU memory 404 for rapid access to model parameters and computation tensors. In typical configurations, each GPU comprises NVIDIA® A100 Tensor Core GPU™, NVIDIA® H100 Tensor Core GPU™, NVIDIA® L40S GPU, AMD® MI300 GPU, Intel® Data Center GPU Max, or equivalent hardware from present or future manufacturers.

GPU memory 404 comprises high-bandwidth memory (HBM™, HBM2™, HBM2e™, or HBM3™) or GDDR6™/GDDR6X™ memory integrated with or closely coupled to the graphics processing units, providing extremely fast access to model parameters and computation tensors during neural network operations. GPU memory 404 stores neural network weights, intermediate activation values during forward and backward passes, embedding vectors for rapid similarity computations, gradient tensors during training operations, and cached computation results to minimize redundant operations. In typical configurations, each GPU in the array includes 16 GB to 192 GB of dedicated high-bandwidth memory with bandwidth ranging from 600 GB/s to 3 TB/s per GPU, enabling the rapid data movement required by modern AI architectures. GPU Memory 404 is co-located with Storage system 405, which provides persistent storage for frequently accessed data including model checkpoints, cached activations, and intermediate results. Storage system 405 comprises high-speed NVMe solid-state drives (SSDs) with transfer speeds exceeding 7 GB/s, enabling sub-millisecond access to critical data.

Network Interface 407 provides high-bandwidth connectivity to external networks and services. Network interface 407 enables bidirectional communication with external systems, cloud services, distributed computing resources, databases, and third-party APIs. Network interface 407 implements high-bandwidth connections ranging from 1 Gigabit per second (Gbps) to 400 Gbps to support concurrent operations and data transfers. The interface manages authentication via secure credential handling, implements rate limiting to respect service quotas, provides retry logic with exponential backoff for transient failures, and maintains connection pooling for efficient resource utilization. Network interface 407 enables high-speed communication (100GbE, InfiniBand, or RDMA over Converged Ethernet) with external systems, cloud services, and data sources with ultra-low latency. This heterogeneous computing architecture is particularly effective for computationally demanding applications including large language model training and inference, real-time computer vision, molecular dynamics simulations, financial modeling, and other workloads that benefit from specialized hardware acceleration working in conjunction with traditional CPU and GPU processing.

AI accelerators 408 represent optional specialized hardware components that may supplement or replace GPU Array 402(A-N) for specific operations. AI accelerators 408 may comprise Google® Tensor Processing Units (TPUs™), which are application-specific integrated circuits (ASICs) configured as specialized neural processing units (NPUs) optimized for matrix multiplication and tensor operations in machine learning workloads. TPUs are particularly effective for computationally intensive tasks including training large language models and transformer architectures for natural language processing applications, accelerating computer vision models for image classification, object detection, and segmentation, performing real-time inference for production language models and recommendation systems, executing protein folding and drug discovery models, and optimizing reinforcement learning workloads for decision-making systems.

AI accelerators 408 may also include custom application-specific integrated circuits (ASICs) designed for neural network inference or training, neural processing units (NPUs) integrated into CPU architectures, field-programmable gate arrays (FPGAs) configured for specialized computational patterns, or other present or future purpose-built hardware accelerators.

These accelerators may be particularly advantageous for high-throughput operations, low-latency inference, specialized data transformations, or custom algorithmic implementations. AI accelerators 408 may communicate bidirectionally with CPU 401 for task coordination and data transfer. In some embodiments, accelerators 408 may be deployed in a heterogeneous computing configuration alongside GPU Array 402(A-N), with the system dynamically assigning tasks to the most appropriate hardware based on workload characteristics, availability, and cost-efficiency considerations.

Computing system 400 may be implemented in various deployment configurations depending on scale requirements and performance objectives. For small-scale deployments, the system may comprise a standalone workstation with CPU 401 (8-16 cores), High-Speed Memory 403 (32-64 GB), GPU Array 402(A-N) with 1-2 consumer-grade or professional GPUs, and standard network connectivity. For medium-scale enterprise deployments, the system may comprise a rackmount server with CPU 401 (32-64 cores), High-Speed Memory 403 (128-256 GB), GPU Array 402(A-N) with 4-8 data center GPUs, high-speed NVMe storage, and 10-100 Gbps network interfaces. For large-scale deployments, multiple instances of computing system 400 may be configured as nodes within a distributed computing cluster, with each node processing a subset of the workload or handling specific stages of the processing pipeline, coordinated via high-speed network interconnects such as InfiniBand or 100/400 Gbps Ethernet.

For maximum scalability and elasticity, computing system 400 may be deployed in cloud computing environments as virtual machines or containers with GPU or TPU attachments. Representative cloud deployment options include Amazon® Web Services (AWS®) EC2® P4/P5 instances, Google® Cloud Platform® A2/A3 GPU instances or TPU™ v5 instances, Microsoft® Azure® NC/ND-series GPU instances, or Oracle® Cloud Infrastructure® GPU instances. Each deployment option provides high-bandwidth memory, interconnected processing elements, and network interfaces suitable for executing the computational workflows described herein.

Cloud deployments enable elastic scaling, where additional compute resources are provisioned automatically during peak processing periods and released during idle times, optimizing cost efficiency while maintaining performance. Alternatively, the system may be deployed in hybrid configurations combining on-premises hardware for baseline workloads with cloud burst capacity for peak demands.

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Detailed Conceptual Architecture

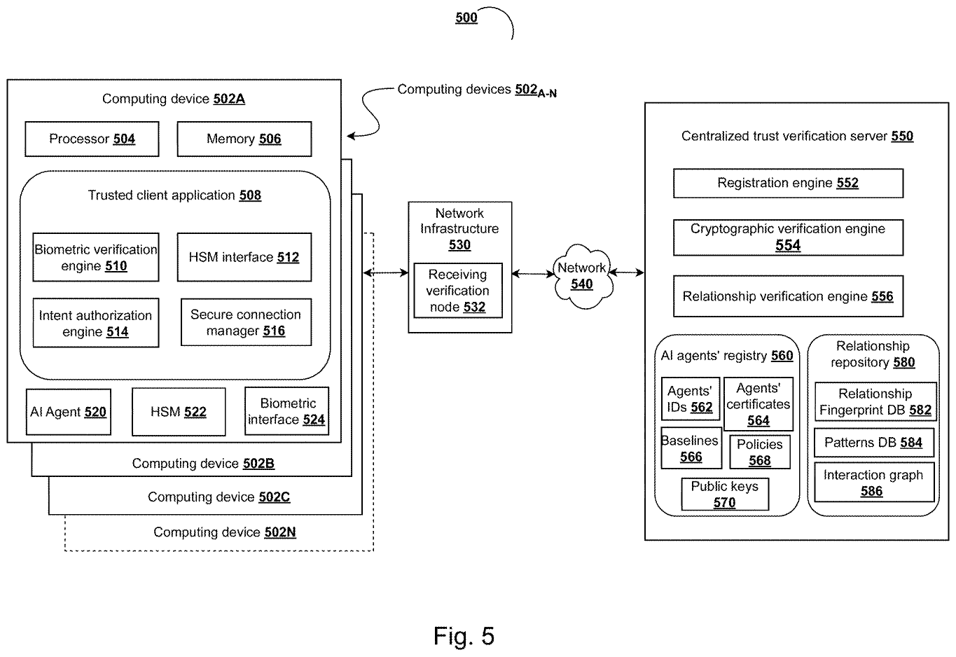

FIG. 5 is an example of a communication system 500 showing a bidirectional trust architecture for secure communications between autonomous artificial intelligence (AI) agents, according to an embodiment of the invention. In an embodiment, a plurality of computing devices 502A-502N (collectively referred to as computing devices 502) are in communication through one or more networks 540 with each other and a centralized trust verification server 550. System 500 may comprise a network infrastructure 530 that may route and deliver communication from one computing device for example, device 502A to another computing device for example device 502B.

In an embodiment, computing devices 502 may include one or more mobile devices, smartphones, general-purpose computers, tablet computers, laptop computers, smart wearable devices Internet-of-Things (IoT) devices or any other device capable of communicating with network 540 including one or more mobile service providers and ultimately communicating via network infrastructure 530 with each other and centralized trust verification server 550. Each computing device 502 is associated with a human owner who may be a registered user of system 500. One subset of computing devices 502 may be owned and used by the registered users which are being monitored for outgoing and incoming communications by one or more components of system 500. Another subset of computing devices 502 may be owned and used by known contacts of the registered users. The remainder may be computing devices of users unknown to the registered users of the system 500.

Each computing device 502 (shown in detail for computing device 502A) may include a processor 504, and a plurality of programming instructions stored in a memory 506, and a trusted client application 508 stored in memory 506. The instructions when executed may be configured to manage communications for computing device 502, according to the embodiments of the invention. Trusted client application 508 is a software application that coordinates all the components of system 500 on computing device 502 and maintains a persistent authenticated connection to centralized trust verification server 550. Trusted client application 508 may be implemented as a native application installed on computing device 502, as a Progressive Web Application (PWA) operating within a browser execution environment and accessing hardware security module (HSM) 522 through the Web Authentication (WebAuthn) standard specified by the W3C and FIDO Alliance, or as a combination of a native companion application handling HSM 522 interactions and a PWA handling the user interface and communication management functions.

As used herein, the term “HSM” refers to a hardware security module that is a dedicated hardware component or subsystem physically resident within a computing device. HSM is capable of generating cryptographic keys internally, storing cryptographic keys exclusively within the hardware boundary such that the keys are inaccessible to any software process external to the hardware component, and performing cryptographic signing operations within the hardware boundary. The term encompasses, without limitation, a secure hardware chip that is a Secure Enclave within an Apple system-on-chip processor, a StrongBox hardware security module or Trusted Execution Environment (TEE) on Android computing devices or a Trusted Platform Module (TPM) within a computing device (e.g., Windows laptop) running a Windows operating system (mandatory since Windows 11 with TPM 2.0).

Each computing device 502 may comprise an autonomous artificial intelligence (AI) agent 520 (referred to as “AI agent” or “agent” herein throughout the specification) capable of initiating and conducting communications on behalf of the user. In an embodiment, agent 520 is a generative AI model that uses natural language processing to extract preferences from conversations, emails, and messaging history to infer optimal communication hours, interests for conversation topics, and priority contacts. Agent 520 is more than simple generative AI agent and may utilize Machine Learning (ML) techniques to continuously improve its communication capabilities. This involves:
Data Collection: Gathering historical data on incoming communications, user preferences, actions taken, and outcomes.
Feature Extraction: Identifying key features from the collected data that are relevant for decision-making, such as sender attributes, communication type, content keywords, and user feedback.
Model Training: Using the extracted features to train ML models, such as decision trees, support vector machines, deep neural networks, or graph neural networks to predict the best actions for handling incoming communications.
Model Evaluation: Testing the trained models on a separate dataset to assess their performance and make any necessary adjustments.
Online Learning: Continuously updating the ML models based on new data and user feedback to adapt to changing user preferences and communication patterns.
Unsupervised Learning: Applying techniques such as clustering and dimensionality reduction to identify hidden patterns and structures within the data, which can provide insights and improve the decision-making process.

By leveraging ML techniques, agents can learn from past experiences and improve its ability to make optimal communications and decisions that align with the user's goals and preferences.

In an embodiment, agent 520 may comprise different AI agents configured to support different types of communications. For example, a first AI agent may be associated with performing voice-based actions, a second AI agent may be associated with handling email communication, and a third AI agent may be associated with text messages.

During the processing of communication, in an embodiment, agent 520 may be utilized to generate communication content based on the communication to be processed. In an embodiment, agent 520 may generate communication content that is shaped by its own processing, language model and capabilities. In another embodiment, agent 520 may also analyze the communication content.

In an embodiment, a user may first register an account with centralized trust verification server 550 with one or more user's computing devices (for example, the computing device 502A) thereby becoming a registered user. The registration is performed via trusted client application 508 installed on the computing device 502A. Trusted client application 508 may be downloaded as a native application from a platform application store (such as the Apple App Store or Google Play Store) or may be accessed as a Progressive Web Application (PWA) through a browser on computing device 502A. During account registration, the user may provide identity information and sets initial preferences, including preferred contacts, preferred communication hours, communication channel preferences, and the user's communication goals if the user wishes.

Trusted client application 508 may initiate the hardware security module key generation process, causing HSM 522 physically resident within the computing device 502A to generate a private cryptographic key internally and store the private key exclusively within the hardware security module. The corresponding public key is transmitted to and registered with centralized trust verification server 550 via secure connection manager 516 of trusted client application 508. Trusted client application 508 may also enroll the user's voice biometric profile by capturing one or more voice samples through biometric interface 524 of computing device 502A and registering the voice biometric profile with biometric verification engine 510 for subsequent identity confirmation.

The user may register multiple computing devices (for example, smartphones, computers, tablet computers, laptop computers, and the like) under the same account, with each computing device generating its own hardware-bound private key within its own HSM and registering the corresponding public key with centralized trust verification server 550. Each registered computing device is capable of independently authorizing processing of a communication on behalf of the user through its own biometric verification engine and hardware security module.

In an embodiment, the user may register AI agent 520 with centralized trust verification server 550 at the time of registering computing device 502A or before processing any communication. The registration of AI agent 520 is performed via trusted client application 508 on computing device 502A. During the registration process, details of AI agent 520 such as agent's skills, capabilities, restrictions, permitted communication types, permitted recipient categories, and agent's provider are shared with centralized trust verification server 550 via trusted client application 508. Trusted client application 508 may compute a cryptographic hash of the agent's entire installed instruction set including every skill, every module, every instruction package and transmit the hash to centralized trust verification server 550 to be stored as a baseline hash in baselines 566.

The agent's installed instruction set may be represented by a canonical agent manifest. The canonical agent manifest may include executable code packages, skill packages, tool definitions, system prompts, developer prompts, policy files, permission grants, model identifiers, model versions, provider identifiers, plug-in identifiers, and configuration files that can affect the communication behavior of AI agent 520. Trusted client application 508, a package manager, a trusted execution environment, or an agent provider may compute the cryptographic hash by canonicalizing the agent manifest, sorting the manifest entries by stable identifier, hashing each manifest entry, and hashing the ordered set of entry hashes. For a remote or provider-hosted AI agent 520, the current hash may be provided as a provider-signed measurement or as an attestation from a trusted execution environment. Centralized trust verification server 550 does not accept a current hash that is supplied only by AI agent 520 without a trusted measurement, provider signature, or trusted execution environment attestation.

The registration process may assign a unique cryptographic identity designation (for example, ClawID) to AI agent 520 and record it in AI agents' registry 560 of centralized trust verification server 550. The registration process also issues a certificate (for example, a Claw Certificate) that attests to the verified identity of the user, the identity and attestation of the provider of AI agent 520, the permitted capabilities and restrictions of AI agent 520, and the cryptographic hash of the agent's installed instruction set at the time of registration. The issued certificate is stored in agents' certificates 564 of AI agents' registry 560 and serves as the capability attestation record for AI agent 520 throughout its registered lifecycle. In an embodiment, AI agents' registry 560 may include the unique identity designation in agents' IDs 562, the capability attestation record in agents' certificates 564, the cryptographic hash of the installed instruction set as baseline hash in baselines 566, the authorized and restricted operations in policies 568, and the public key of the computing device's hardware security module in public keys 570. Any modification of the agent's installed instruction set at any time after registration causes the cryptographic hash to change from the recorded baseline 566, which in turn causes the certificate to become invalid, requiring the user to re-register AI agent 520 through trusted client application 508. This provides a detection mechanism for supply chain attacks, malicious skill injections, and unauthorized modifications to the agent's behavior.

Referring to FIG. 5 again, in an embodiment, trusted client application 508 may comprise a biometric verification engine 510, an HSM interface 512, an intent authorization engine 514, and a secure connection manager 516. Biometric verification engine 510 may be responsible for receiving voice commands from the user through biometric interface 524, performing voice biometric analysis and producing a biometric authorization signal and a biometric attestation upon successful identity verification. HSM interface 512 may be responsible for providing the software interface through which trusted client application 508 communicates with HSM 522 Intent authorization engine 514 may be responsible for constructing an intent data structure comprising the recipient information, the communication intent, the communication channel, the authorized and prohibited operations, the expiry timestamp, and the nonce, and assembling the intent data structure into an intent token for submission to HSM 522 for signing. Secure connection manager 516 may be responsible for establishing and maintaining a persistent authenticated connection between trusted client application 508 and centralized trust verification server 550.

In an embodiment, the user of computing device 502A may issue a voice command specifying a communication to be processed by the AI agent 520 when the user (or a sender) wishes to send or convey the communication to a recipient i.e., a user of another computing device (for example, computing device 502B). The voice command may include the intended recipient and a communication channel through which communication is to be transmitted. The communication channel may include a voice message, an audio call, a text message, an email, or a video communication.

In an embodiment, biometric verification engine 510 may be configured to receive the voice command from the user through biometric interface 524, which accesses a microphone of computing device 502A. Biometric verification engine 510 may perform voice biometric verification based on the received voice command on receipt of the voice command. In an embodiment, biometric verification engine 510 analyzes the voice command to identify the voice of the user based on a registered voice biometric profile of the user. The registered voice biometric profile captures acoustic characteristics unique to the user, including pitch, cadence, spectral features, and vocal tract resonance patterns. Biometric verification engine 510 extracts a voice biometric feature vector from the acoustic characteristics of the voice command and computes a matching score of the voice biometric feature vector against the registered voice biometric profile. When the matching score meets or exceeds a predetermined authentication threshold, the biometric verification is successful, and the identity of the user is confirmed. Upon biometric verification, biometric verification engine 510 may produce a biometric authorization signal that is an internal, on-device output of the biometric verification. Biometric verification engine 510 may internally transmit the biometric authorization signal to HSM interface 512 to process a signing operation that includes signing of an intent token (discussed later). In other words, the biometric authorization signal gates or authorizes HSM 522 to perform the signing operation. In an embodiment, the biometric authorization signal stays on computing device 502A. The voice biometric modality enables proximity-independent operation, allowing the user to authorize communications from any distance within microphone range of computing device 502A without requiring the user to be in physical proximity, physical contact or to establish visual alignment to computing device 502A.

In embodiments where voice command activation is unavailable or speaking a voice command is not possible for the user, the biometric verification may be performed using face recognition or fingerprint identification in place of the voice identification. In an embodiment, the biometric authorization signal may be produced by facial recognition or fingerprint identification through a biometric interface 524 of the operating system of computing device 502A. In an example, if the user is in a loud environment, or in a quiet library, or the communication is text-based, the user may type a command in the trusted client application 508 for AI agent 520 to process the communication. In response, biometric interface 524 may prompt the user for face recognition or fingerprints identification. For example, Apple devices prompt Face ID or Touch ID, Android devices prompt fingerprint sensors, and a Window PC prompts face recognition through Windows Hello's IR camera. Upon confirmation of face recognition or fingerprint identification, HSM 522 performs the signing operation.

Along with the biometric authorization signal, biometric verification engine 510 may produce a biometric attestation, in an embodiment. The biometric attestation may comprise a structured data record produced by biometric verification engine 510 upon successful identity verification. The biometric attestation comprises a biometric modality employed (voice biometric, facial recognition, or fingerprint recognition); a matching score reflecting the strength of the biometric match against the registered biometric profile; a timestamp of the biometric verification event expressed in Coordinated Universal Time; a device attestation identifying the hardware platform and the hardware security module on which the biometric verification was performed; and optionally, a cryptographic signature produced by biometric verification engine 510 attesting to the integrity of the biometric verification event.

In an embodiment, the biometric attestation includes a digest of the intent token, the nonce included in the intent data structure, and a session identifier associated with the biometric verification event. The biometric attestation may be signed by HSM 522, by a platform attestation key, or by another device-resident attestation key that is inaccessible to AI agent 520. Centralized trust verification server 550 verifies the attestation signature, verifies that the intent-token digest in the biometric attestation matches the signed intent token, and verifies that the nonce and session identifier in the biometric attestation corresponds to the nonce and session used for the signing operation. An unsigned biometric attestation may be used for local logging, user display, or diagnostic purposes, but is not relied upon by centralized trust verification server 550 as independent remote proof of biometric verification.

In an embodiment, intent authorization engine 514 may parse the voice command received from the user to extract structured intent fields and construct the intent data structure of the intent token. The intent data structure comprises information of the recipient identifying the intended other user as parsed from the voice command, including the recipient's name, contact identifier, or relationship designation (for example, “Dr. Patel's office,” “my accountant,” or “the vendor we spoke with last week”); an intent of the communication specifying the purpose and authorized scope of the communication (for example, “reschedule my Thursday appointment,” “discuss quarterly tax filing,” or “request an updated price quote”), and metadata of the voice command including a timestamp expressed in Coordinated Universal Time, contextual information specifying communication patterns and relationship context relevant to the communication, and the communication channel through which the communication is to be transmitted (for example, voice call, text message, electronic mail, or messaging platform).

In addition, intent authorization engine 514 may include an expiry timestamp in the intent data structure, after which the intent token is no longer valid. The expiry timestamp may be set to a period not exceeding ten minutes from the construction timestamp, limiting the temporal window during which the authorization may be used and preventing stale authorizations from being acted upon later. Intent authorization engine 514 may further include a cryptographically random nonce in the intent data structure, ensuring the uniqueness of each intent token and preventing replay attacks where an attacker attempts to resubmit a previously captured valid intent token.

In an embodiment, intent authorization engine 514 may further include in the intent data structure a set of authorized communication operations specifying operations, functions, or types of communications that the AI agent 520 is permitted to perform while processing the communication (for example, scheduling or rescheduling appointments, requesting pricing information, confirming delivery dates, or providing project status updates) and a set of prohibited communication operations specifying operations, functions or type of communication that the AI agent 520 is explicitly prohibited from performing while processing the communication (for example, disclosing medical history, revealing financial account numbers, sharing salary or compensation details, agreeing to contractual terms, authorizing payments or transactions, or providing personal identification information such as social security numbers or dates of birth).

In an embodiment, HSM interface 512 may submit the intent token to HSM 522 for the signing operation. In an embodiment, HSM interface 512 provides a software interface through which trusted client application 508 communicates with HSM 522. On Apple devices, HSM interface 512 may utilize a secure enclave key generation API, such as SecKeyCreateRandomKey API with the kSecAttrTokenIDSecureEnclave attribute. On Android devices, HSM interface 512 may utilize the Android KeyStore System with the StrongBox attribute. In an embodiment where trusted client application 508 is implemented in the form of PWA, HSM interface 512 may access HSM 522 through the Web Authentication (WebAuthn) standard specified by the W3C and FIDO Alliance, where HSM 522 functions as a platform authenticator accessible through a browser execution environment without requiring installation of a native application. This platform agnostic access through the WebAuthn standard enables the same cryptographic authorization architecture to operate across every major computing platform such as iPhone, Android, Windows PC, and Mac through a single standard.

In some embodiments, HSM interface 512 implements the biometric authorization signal as a platform user-verification state, authorization handle, or session-bound challenge generated by biometric verification engine 510, biometric interface 524, a trusted execution environment, an operating-system biometric framework, or an authenticator API. HSM interface 512 submits a digest of the intent token together with the authorization handle to a key object in HSM 522 that is configured to require user verification for each signing operation. By way of example, the key object may be configured using Secure Enclave access-control attributes, Android KeyStore user-authentication parameters, a TPM policy session, or a WebAuthn platform-authenticator request in which user verification is required. HSM 522 rejects the signing operation when the authorization handle is absent, expired, not generated by a trusted biometric process, or not associated with the same session as the intent token digest.

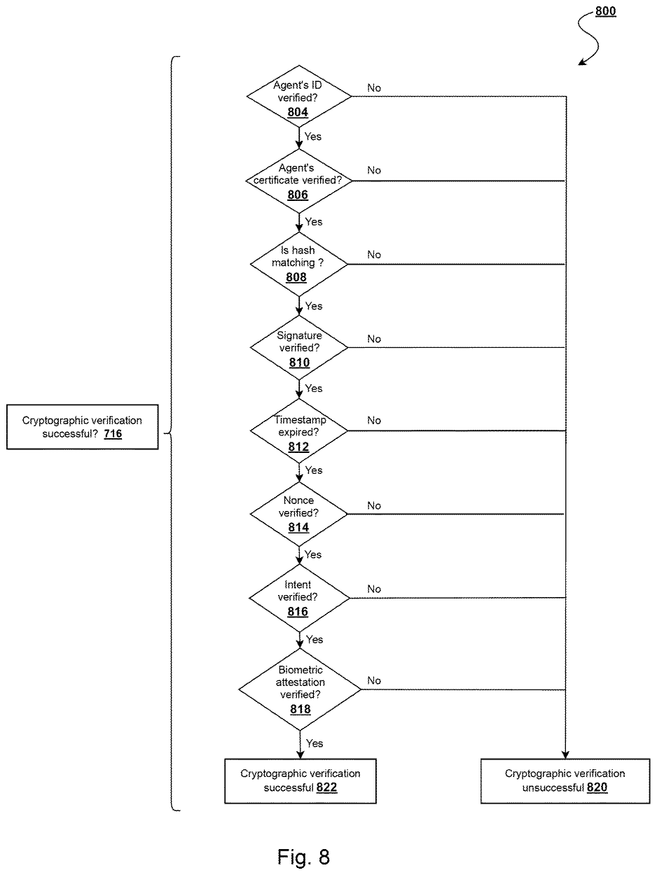

In an embodiment, upon receipt of the biometric authorization signal from biometric verification engine 510 via HSM interface 512, HSM 522 may perform a signing operation of the intent token. In an embodiment, the signing operation may be referred to as cryptographic signing operation of cryptographic signing of the intent token. HSM 522 may perform the signing operation using the private cryptographic key stored exclusively within the hardware boundary of the hardware security module. The private key is generated within HSM 522, stored exclusively within HSM 522, and is inaccessible to any software process, operating system, application, or external system running on the computing device or on any remote system. In an embodiment, in absence of the biometric authorization signal, system 500 precludes HSM 522 from performing the signing operation of the intent token. That is, HSM 522 does not perform the signing operation without the biometric authorization signal regardless of any request from a software process, application, or AI agent. The biometric authorization signal is the sole gate that unlocks the signing capability of the HSM 522. The cryptographic signing operation may produce a signed intent token. The resulting digital signature is mathematically bound to both the specific content of the intent data structure and the specific private key stored in HSM 522, such that any modification to any field of the intent token after signing, including the recipient, the authorized operations, the prohibited operations, the expiry timestamp, or the nonce will cause signature verification to fail at centralized trust verification server 550. Any attempt to produce a valid signed intent token without physical access to the HSM 522 containing the private key and without satisfying the biometric authentication of the registered owner is computationally infeasible. The corresponding public key, which is capable of verifying signatures produced by the private key but cannot itself produce signatures, is transmitted to and registered with centralized trust verification server 550 via secure connection manager 516 during the initial registration process described herein. Centralized trust verification server 550 may store the public key in public keys 570 of AI agents' registry 560 and use it to verify the signed intent token when received during the cryptographic verification described in conjunction with FIG. 8.

In an embodiment, the voice command simultaneously triggers biometric authentication by biometric verification engine 510, intent token construction by intent authorization engine 514 and cryptographic signing by HSM 522 in a single user interaction requiring no additional steps. The entire sequence including the receipt of voice command, the confirmation of the voice biometric identity, the production of the biometric authorization signal, the generation of the biometric attestation, construction of the intent data structure, and signing of the intent token (upon receipt of the biometric authorization signal), occurs within the single voice interaction that initiates the communication. The user may not need to perform any additional action, touch any button, look at any screen, or provide any further confirmation beyond the original voice command. This single-interaction authorization is enabled by the proximity-independent nature of the voice biometric modality. The user may be at any distance from the computing device within microphone range, the voice command serves simultaneously as the instruction to the AI agent, the biometric identity sample, and the authorization trigger.

In an embodiment, secure connection manager 516 may maintain a persistent authenticated connection between trusted client application 508 and centralized trust verification server 550. The persistent connection ensures that verification requests and responses are transmitted with minimal latency. In an embodiment, secure connection manager 516 may be configured to transmit the signed intent token and the biometric attestation to centralized trust verification server 550 for cryptographic verification and relational consistency verification based on the intent data structure. The signed intent token may be transmitted so that cryptographic verification engine 554 at centralized trust verification server 550 can perform a cryptographic verification of the signed intent token and a relational consistency verification of the user (may also be referred to as “sender” or “caller”) and the recipient based on the intent data structure and thereby confirming that a specific human owner, authenticated through biometrics on a specific physical device, has authorized the communication to be processed. The biometric attestation may be transmitted alongside the signed intent token so that centralized trust verification server 550 can independently verify the biometric event that gated the signing operation, which may confirm the biometric modality employed, the confidence score of the biometric match, the timestamp of the biometric verification event, and the device attestation identifying the hardware platform. Together, the signed intent token and the biometric attestation may provide centralized trust verification server 550 with the complete evidence required to produce a trust determination, for example, the signed intent token proves what was authorized and that the authorization is cryptographically genuine, and the biometric attestation proves how the human owner's identity was confirmed and with what degree of confidence.

The biometric authorization signal is an internal authorization condition, authorization handle, or device-local control signal generated within computing device 502A in response to successful biometric verification. The biometric authorization signal is used by HSM interface 512 to permit HSM 522 to perform the signing operation and is not transmitted to centralized trust verification server 550. In a preferred embodiment, biometric attestation is a separate structured data record transmitted to centralized trust verification server 550 with the signed intent token and identifies the biometric verification event that produced the biometric authorization signal.

Referring to FIG. 5, in an embodiment, centralized trust verification server 550 is a server system operating as shared infrastructure serving all registered users and their AI agents. Accordingly, all computing devices 502 may connect to the same centralized trust verification server 550. In an embodiment, centralized trust verification server 550 may comprise a registration engine 552, a cryptographic verification engine 554, and a relationship verification engine 556. In addition, centralized trust verification server 550 further comprises an AI agents' registry 560 and a relationship repository 580 accessible for a pre-initiation verification including a cryptographic verification and a relational consistency verification before processing any communications between registered AI agents of any pair of computing devices 502. The centralized architecture is essential for the functioning of system 500 because bidirectional verification requires access to both AI agents' registration data and their mutual relationship data from a single authoritative source.

In an embodiment, registration engine 552 manages the registration of users, their computing devices, their AI agents, and their public cryptographic keys. On registering a new user, registration engine 552 creates a user account in centralized trust verification server 550, associates the user's identity information with the account, and stores the user's initial preferences including preferred contacts, communication hours, channel preferences, and communication goals. On registering a computing device (for example, computing device 502A), registration engine 552 may receive the public cryptographic key corresponding to the private key generated within HSM 522 and store it in public keys 570 of AI agents' registry 560 and record the device attestation identifying the hardware platform and type of hardware security module. A single user account may be associated with multiple registered computing devices, each maintaining its own hardware-bound private key. On registering an AI agent (for example, AI agent 520), registration engine 552 may assign a unique cryptographic identity designation (for example, a ClawID) to AI agent 520 and store it in AI agents' registry 560, record the agent's capabilities and restrictions in policies 568, compute and store the cryptographic hash of the agent's installed instruction set as the baseline hash in baselines 566, issue a certificate (for example, a Claw Certificate) attesting to the user's identity, the agent's provider, the agent's permitted capabilities, and the instruction set hash, and store the certificate in agents' certificates 564. Registration engine 552 may further associate the registered AI agent with every relationship fingerprint the user has accumulated in relationship fingerprint database 582, such that the agent's communications are evaluated against the same relationship fingerprints that govern the user's direct communications. On deregistering or revoking an AI agent or computing device, registration engine 552 may invalidate the corresponding records in AI agents' registry 560, such that any subsequent communication attempt by the revoked entity will fail during the cryptographic verification described in FIG. 8.

In an embodiment, AI agents' registry 560 may include the unique identity designation in agents' IDs 562, the capability attestation record in agents' certificates 564, the cryptographic hash of the installed instruction set in baselines 566, the authorized and restricted operations in policies 568, and the public key of the computing device's hardware security module in public keys 570. Any modification of the agent's installed instruction set at any time after registration causes the cryptographic hash to change from the recorded baseline 566, which in turn causes the certificate to become invalid, requiring the user to re-register AI agent 520 through trusted client application 508. This provides a detection mechanism for supply chain attacks, malicious skill injections, and unauthorized modifications to the agent's behavior.

In an embodiment, relationship repository 580 may comprise a relationship fingerprint database 582 storing for each pair of communicating users a behavioral model derived from metadata of their historical communications, the behavioral model encoding communication frequency, timing, channel distribution, topic distribution, reciprocity, and behavioral pattern stability across one or more communication channels, a patterns database 584 storing aggregated communication patterns used across services and networks, and an interaction graph 586 maintaining nodes representing users and devices, edges representing relationships, and communication history and patterns. The interaction graph 586 may provide relationship context for communication between users. Relationship fingerprints naturally evolve as relationships develop, becoming more sophisticated over time, making spoofing mathematically difficult since attackers cannot fabricate the complex pattern history that defines real relationships.

In an embodiment, upon receiving the signed intent token at centralized trust verification server 550, cryptographic verification engine 554 may perform cryptographic verification of the signed intent token. Cryptographic verification may comprise verifying the cryptographic identity of the AI agent against AI agents' registry 560, verifying the capability attestation record including the cryptographic hash of the installed instruction set, validating the cryptographic signature of the signed intent token using the user's registered public key, verifying that the expiry timestamp has not been exceeded, and verifying that the nonce has not been previously processed. Cryptographic verification is described in detail in conjunction with FIG. 8. In an embodiment, when cryptographic verification is unsuccessful, centralized trust verification server 550 may transmit a termination instruction to computing device 502A to abort the processing of the communication. Upon receiving the termination instruction, AI agent 520 does not process the communication, and does not transmit any communication towards the recipient.

In an embodiment, centralized trust verification server 550 may also receive biometric attestation along with the signed intent token. Cryptographic verification engine 554 may analyze the biometric attestation as part of the cryptographic verification process, in an embodiment. Cryptographic verification engine 554 may verify the biometric attestation record by confirming that the biometric modality recorded in the attestation is a recognized modality (voice biometric, facial recognition, or fingerprint recognition), that the confidence score meets or exceeds a minimum confidence threshold, and that the timestamp of the biometric verification event is recent and consistent with the intent token construction timestamp, which confirms that the biometric verification occurred at approximately the same time as the intent token was generated, thereby preventing an attacker from pairing a stale biometric attestation with a newly generated intent token. Cryptographic verification engine 554 may further confirm that the device attestation identifies a recognized hardware platform with a known hardware security module type. Cryptographic verification engine 554 may further verify the signature of the biometric attestation and confirm that the biometric attestation is bound to the signed intent token by comparing the intent-token digest, nonce, and session identifier in the biometric attestation with the corresponding values associated with the signed intent token. Centralized trust verification server 550 may log the biometric authentication event in association with the user's account, creating an auditable record including the biometric modality employed, the confidence score, the timestamp, the device attestation, and the identity of the AI agent. This audit trail may enable the user to review, through trusted client application 508, a complete history of all biometric authorization events associated with their account, providing visibility into when, how, and from which device the communication was authorized.

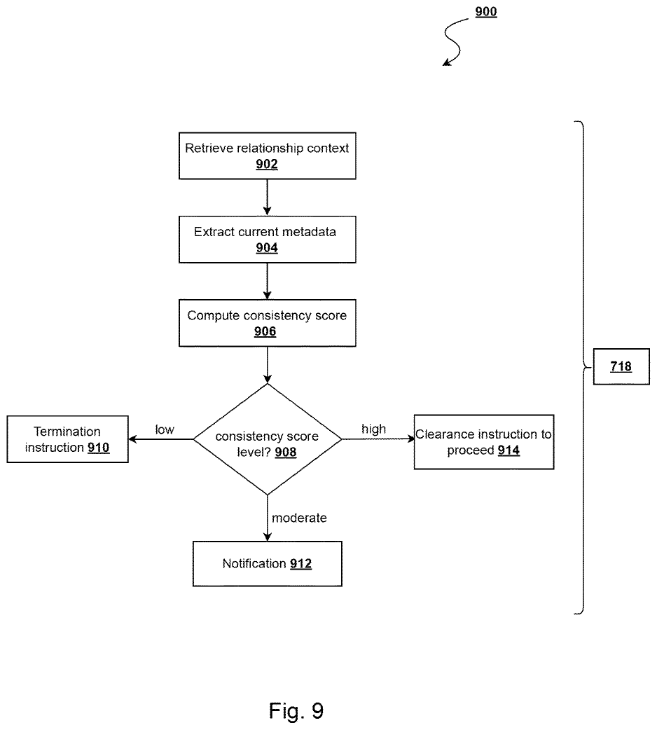

In an embodiment, upon successful cryptographic verification, relationship verification engine 556 may perform relational consistency verification based on the intent data structure of the signed intent token. Relational consistency verification may comprise analyzing the intent of the communication, including the intended recipient, the communication channel, the timing, and the topic against relationship fingerprints stored in relationship fingerprint database 582 of relationship repository 580. Relationship fingerprints, as established by the parent invention U.S. Pat. No. 12,388,880, which is incorporated herein by reference, are behavioral models derived from metadata of historical communications between pairs of users. Each relationship fingerprint encodes how two specific users communicate over time, capturing communication frequency, timing patterns, channel distribution and preference, topic distribution, reciprocity, and behavioral pattern stability across one or more communication channels. The relationship fingerprint may evolve continuously as the relationship develops, becoming increasingly precise with each interaction and making fabrication mathematically difficult since an attacker cannot reproduce the complex pattern history that develops organically between two real users over time. Relationship verification engine 556 may compute a multi-attribute behavioral consistency score by comparing the metadata of the current communication against the behavioral model stored in the relationship fingerprints for a pair of users, evaluating each behavioral dimension independently and aggregating the per-dimension results through a weighted function as described in detail in conjunction with FIG. 9. The relational consistency verification thereby determines whether the communication is consistent between two specific users based on their relationship fingerprints.

In an embodiment, when the behavioral consistency score is low, such as below 50, the relational consistency verification may be unsuccessful. A low consistency score may indicate that the communication's behavioral metadata is severely inconsistent with the established relationship fingerprints, with multiple dimensions flagged as anomalous showing extreme deviation. In such an embodiment, centralized trust verification server 550 may transmit a terminate instruction to abort the processing of the communication.

In an embodiment, when the behavioral consistency score is moderate, such as 50 to 74, relational consistency verification may be unsuccessful. A moderate consistency score may indicate that the communication's behavioral metadata shows some deviation from the established relationship fingerprints but is not severely inconsistent. Centralized trust verification server 550 may transmit a notification identifying the specific behavioral dimensions that deviate from the established pattern (for example: unusual timing, atypical channel, or elevated frequency), to the computing device 502A in response to the unsuccessful relational consistency verification. The user may review the notification, and may provide confirmation to proceed, in which case AI agent 520 proceed to process the communication or decline to proceed, in which case the communication is aborted. This mechanism ensures that the user (i.e., human owner) has final authority over communications that deviate from established behavioral patterns while preserving the ability to initiate legitimate but unusual communications.

In an embodiment, when the behavioral consistency score is high, such as 75 or greater, relational consistency verification may be successful. A high consistency score may indicate that the communication's behavioral metadata is consistent with the established relationship fingerprints. Responsive to successful cryptographic verification and relational consistency verification, centralized trust verification server 550 may send a clearance instruction to computing device 502A via secure connection manager 516 to proceed with processing of the communication. The clearance instruction may allow AI agent 520 to initiate communication, and in turn, AI agent 520 may transmit an AI-mediated communication based on the voice command and the intent data structure, along with the signed intent token and the biometric attestation, towards the recipient through network 540.

An AI-mediated communication, as used herein, refers to a communication in which the content, language, conversational responses, and interaction dynamics are produced by AI agent acting on behalf of the human owner or user, based on the intent data structure encoded in the signed intent token. The AI-mediated communication is the actual communication that the AI agent generates and transmits to the recipient, including the words the agent speaks on a voice call, the text the agent composes in a message, or the content the agent writes in an email. The AI-mediated communication is distinguished from the owner's authorized intent in that the authorized intent, as encoded in the intent data structure, specifies the permitted scope and prohibited boundaries of the communication, while the AI-mediated communication is the actual content produced by the agent's language model and instruction set within the authorized scope specified in the intent data structure. The user when speaking the voice command, specifies what the communication should accomplish and what it must not disclose, and the AI agent autonomously generates the actual content in real time during the interaction with the recipient. It may be possible that AI agent's actual output may deviate from the owner's authorized intent whether through prompt injection, a compromised instruction set, or the inherent unpredictability of autonomous language generation.

In an embodiment, trusted client application 508 or AI agent 520 may evaluate the AI-mediated communication before transmission to determine whether the AI-mediated communication complies with the intent data structure of the signed intent token. The evaluation may compare the proposed AI-generated content against the recipient, communication channel, authorized communication operations, prohibited communication operations, expiry timestamp, and other constraints encoded in the signed intent token. When the proposed AI-generated content is outside the authorized scope or includes content corresponding to a prohibited communication operation, trusted client application 508 or AI agent 520 may block the content, revise the content to comply with the intent data structure, request renewed biometric authorization, or terminate the communication.

AI agent 520 may produce the AI-mediated communication to be transmitted through any of the communication channels such as voice calls, text message, electronic mail, etc. according to received voice command or recommended by the user, which is also encoded in the intent data structure of the signed intent token. In an embodiment, AI agent 520 transmits the AI-mediated communication through the specified channel. The systems and methods of the present invention apply uniformly to multiple communication channels, and the biometric verification, intent token generation, cryptographic signing, cryptographic verification, and relational consistency verification operate identically regardless of the communication channel.

In an embodiment, system 500 may support the multiple communication channels through which AI agent 520 may transmit the AI-mediated communication on behalf of the sender. For example, voice calls may be transmitted via a Session Initiation Protocol (SIP) signaling message, wherein the signed intent token and biometric attestation are transmitted as structured extension header fields of a SIP INVITE message; text messages may be transmitted via Short Message Service (SMS), Multimedia Messaging Service (MMS), or Rich Communication Services (RCS) protocols, wherein the signed intent token is transmitted as a metadata field accompanying the message, or in protocols with limited metadata capacity such as legacy SMS, an abbreviated attestation reference is transmitted and the full signed intent token is retrievable from centralized trust verification server 550; electronic mail messages may be transmitted via standard mail transfer protocols, wherein the signed intent token is transmitted as an additional header field conforming to RFC 5322, compatible with and complementary to existing email authentication standards including DomainKeys Identified Mail (DKIM) and Sender Policy Framework (SPF); and some communications may be transmitted through third-party messaging platforms, collaboration tools, or other application-layer communication channels, wherein the signed intent token is transmitted as a structured field within the API request payload or message metadata according to the API specifications of the relevant platform.

In an embodiment, a network infrastructure 530 may operate between the communication channel and the recipient's computing device 502B. Network infrastructure 530 may be configured to deliver a communication transmitted from one computing device (for example, computing device 502A) to a recipient's computing device (for example, computing device 502B). In an embodiment, network infrastructure 530 may receive the AI-mediated communication including the signed intent token and biometric attestation transmitted by the AI agent 520 of the computing device 502A for delivering to the recipient computing device 502B. In an embodiment, a receiving verification node 532 may operate at network infrastructure 530. Receiving verification node 532 is a software component or module deployed at network infrastructure 530. Receiving verification node 532 may be configured to route any communication based on a routing decision determined by performing cryptographic verification and relational consistency verification of the communication that passes through network infrastructure 530 before delivering to recipient computing device 502B. Receiving verification node 532 may be implemented as a software module integrated into a carrier's Session Initiation Protocol (SIP) routing infrastructure for voice communications, as a processing plugin within a mail transfer agent for electronic mail communications, or as an application programming interface integration within a third-party messaging platform's delivery pipeline.

In an embodiment, before delivering the AI-mediated communication to the recipient computing device 502B, receiving verification node 532 may perform pre-delivery verification including the cryptographic verification and the relational consistency verification of the AI-mediated communication transmitted from AI agent 520. In an embodiment, network infrastructure 530 routes the AI-mediated communication based on a routing decision determined by receiving verification node 532 based on the pre-delivery verification.

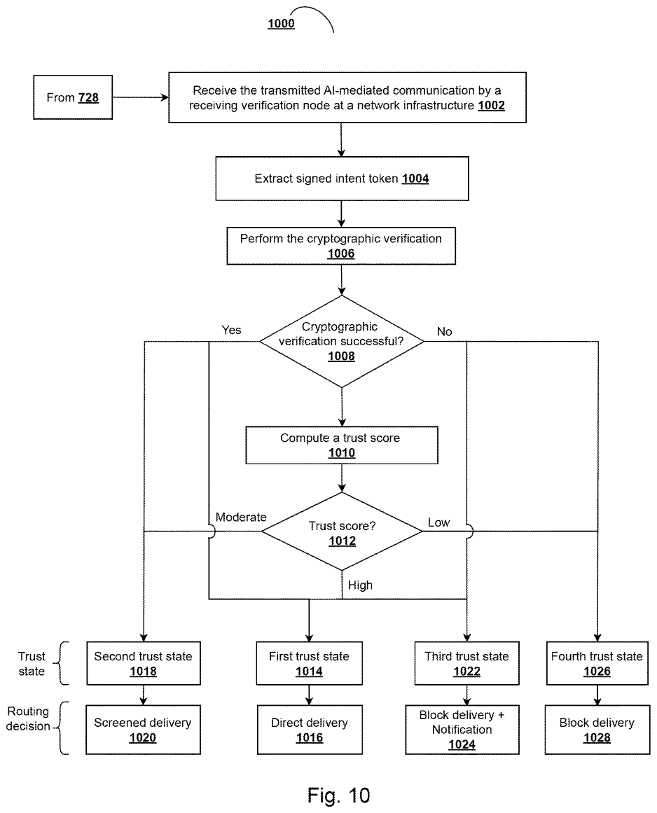

On receiving the AI-mediated communication, receiving verification node 532 may extract the signed intent token and the biometric attestation from the structured header or metadata fields of the AI-mediated communication. To perform the verification, receiving verification node 532 may query centralized trust verification server 550 over a secure channel, by transmitting the extracted credentials for verification against the data stored at the server including the first user's public key in public keys 570, the agent's registration status and baseline hash in AI agents' registry 560, the nonce processing history, and the relationship fingerprint for the first user and second user pair in relationship fingerprint database 582. In an embodiment, centralized trust verification server 550 may perform the cryptographic verification and relational consistency verification on behalf of receiving verification node 532 and return the trust determination. In an alternative embodiment, receiving verification node 532 may maintain a local cache of frequently accessed public keys and agent registration data, performing signature verification and basic credential checks locally while querying centralized trust verification server 550 for the relational consistency verification that requires access to the relationship fingerprint repository 580. In either embodiment, based on the trust determination produced from the combined output of the cryptographic verification and the relational consistency verification, receiving verification node 532 may enforce a routing decision that comprises a direct delivery, a screened delivery, or a block delivery of the AI-mediated communication to recipient's computing device 502B. The pre-delivery process and routing decision process are described in detail in conjunction with FIG. 10.

In an embodiment, centralized trust verification server 550 may generate a trust score as part of the trust determination based on the relationship fingerprint for the pair of users stored in relationship fingerprint database 582. The trust score is a numerical value on a scale of 0 to 100 that quantifies the trustworthiness of communication based on the established relationship between the pair of users, independent of and complementary to the cryptographic verification of the signed intent token. The trust score may be derived from individual trust attribute scores computed from the behavioral model encoded in the relationship fingerprint for the pair of users, each trust attribute capturing a distinct dimension of the communication relationship.

In an embodiment, relationship verification engine 556 may compute the following individual trust attributes from the relationship fingerprint for the pair of users.

An engagement rate may measure the frequency and quality of interactions between the pair of users and is calculated using the formula:

Engagement Rate=(Total Interactions×Average Duration×Reciprocity Factor)/Time Period
where Reciprocity Factor measures bidirectional engagement quality on a scale of 0.1 to 1.0 reflecting whether the communication relationship is mutual or predominantly one-directional.

A reliability index may assess the consistency and dependability of communication patterns between the pair of users and may be calculated as:

Reliability Index=(Temporal Consistency×Channel Consistency×Response Consistency)/3,
where each consistency factor is measured on a 0 to 100 scale, with higher values indicating more predictable and stable communication patterns.

A channel preference score may indicate alignment of the current communication channel with the established channel distribution of the relationship and may be calculated as:

Channel Preference Score=(Current Channel Usage Frequency/Total Communications)×Channel Appropriateness Factor
where Channel Appropriateness Factor considers context such as time of day and relationship type on a scale of 0.1 to 1.0.

A temporal pattern score may reflect whether the timing of the current communication is consistent with historical timing characteristics of the relationship, computed using statistical analysis of historical timing data with standard deviation calculations to measure the degree to which the current communication timing falls within the established temporal distribution of the relationship.

A behavioral pattern score may capture whether the interaction style of the current communication is consistent with established interaction behaviors of the relationship, including communication length, response timing, interaction complexity, and the degree of formality characteristic of the relationship, classified using machine learning algorithms that analyze metadata characteristics.

In an embodiment, each individual trust attribute is normalized to a standardized scale of 0 to 100. Relationship verification engine 556 may generate the trust score by combining the normalized individual trust attribute scores through a weighted aggregation function:

Trust Score=(wₑ×Engagement Rate)+(wᵣ×Reliability Index)+(w_{c}×Channel Preference Score)+(wₜ×Temporal Pattern Score)+(w_{b}×Behavioral Pattern Score)
where wₑ, wᵣ, w_{c}, wₜ, and w_{b} are weights that sum to 1.0 and are determined based on the communication context, the depth of the relationship history, and the degree of cross-channel pattern consistency available for the pair of users. For relationships with deeper communication history and consistent cross-channel patterns, the weighting function may assign greater weight to the reliability index and behavioral pattern score, which become more discriminative as the relationship matures. For newer relationships with limited history, the weighting function may assign greater weight to the temporal pattern score and channel preference score, which provide meaningful signals even with fewer historical data points. The weighting function may further assign amplified weight to any individual trust attribute that deviates beyond a per-attribute anomaly threshold value, consistent with the anomaly-weighting mechanism described in conjunction with the multi-attribute behavioral consistency score of FIG. 9, such that a severe deviation on any single trust dimension prevents the trust score from remaining high even if the remaining dimensions are within normal ranges. In an embodiment, the anomaly threshold values may be configurable based on the security requirements of the deployment, the preferences of the registered user, or the policies established by an operator of the centralized trust verification server or an enterprise administrator responsible for managing a plurality of registered users within an organization.

In an embodiment, all individual trust attributes and the trust score may be computed exclusively from communication metadata encoded in the relationship fingerprint without accessing the content of any communication. The trust score may be computed by relationship verification engine 556 at centralized trust verification server 550 and is made available to receiving verification node 532 as part of the trust determination transmitted in response to the pre-delivery verification query, and to the recipient's computing device 502B as part of the inbound verification information presented through trusted client application 508. The trust score computation and individual trust attributes described herein are further described in co-pending U.S. patent application Ser. No. 19/350,012 filed on 5 Oct. 2025, entitled “SYSTEM AND METHOD FOR COMMUNICATION VALIDATION AND MULTI-ATTRIBUTE TRUST SCORING THROUGH CROSS-NETWORK INTELLIGENCE CORRELATION” which is incorporated herein by reference in its entirety. The relationship fingerprint, relational consistency verification, individual trust attribute, and trust score embodiments described herein may be implemented using relationship repository 580, relationship fingerprint database 582, patterns database 584, interaction graph 586, relationship verification engine 556, and receiving verification node 532. The incorporated application may provide additional examples of communication validation and trust scoring, but the relationship fingerprint and trust score operations may be performed using the structures and operations described in this application.

The pre-delivery verification by receiving verification node 532 operates independently of and in addition to the pre-initiation verification performed by centralized trust verification server 550 before initiating the communication. The pre-initiation verification at centralized trust verification server 550 confirms that the user authorized the communication and that the communication intent is consistent with the established relationship, but that verification occurs before the AI agent 520 generates and transmits the AI-mediated communication. Between the moment centralized trust verification server 550 grants clearance and the moment AI-mediated communication reaches the recipient, several conditions may change that could compromise the integrity or appropriateness of the communication. The AI agent's behavior during the actual communication may deviate from the user's authorized intent whether through prompt injection encountered during the interaction, a latent compromise in the agent's instruction set that activates only under specific conversational conditions, the inherent unpredictability of autonomous language generation by the agent's underlying model, or manipulation by the recipient or a third party during a multi-turn conversation. The agent's registration status may have been revoked by the user or by the system after the pre-initiation clearance was granted but before the communication reaches the recipient. The relationship context between the users (the sender or caller and the recipient) may have changed for example, another communication from the same sender may have arrived in the interim, elevating the frequency beyond normal patterns and triggering an anomaly that did not exist at the time of pre-initiation verification. By performing its own independent cryptographic verification and relational consistency verification at the network infrastructure 530 immediately before delivery, receiving verification node 532 evaluates the communication as it actually exists at the point of delivery, not as it was anticipated at the point of authorization. This pre-delivery verification ensures that the communication that was legitimately authorized and cleared at the pre-initiation stage but that has since become compromised, stale, or contextually inappropriate is caught before it reaches the recipient, providing the recipient with a layer of protection that does not depend on the continued integrity of the sender's AI agent or the continued validity of the pre-initiation authorization. This way, the system operates bidirectionally in which both the users are simultaneously protected as a recipient by the receiving verification node and held accountable as a sender by the pre-initiation verification at the centralized trust verification server, and provides a symmetric trust architecture in which the same verification standards, the same relationship fingerprints, and the same trust determination process apply to communications in either direction between any pair of registered users.

### Detailed Description of Exemplary Embodiments

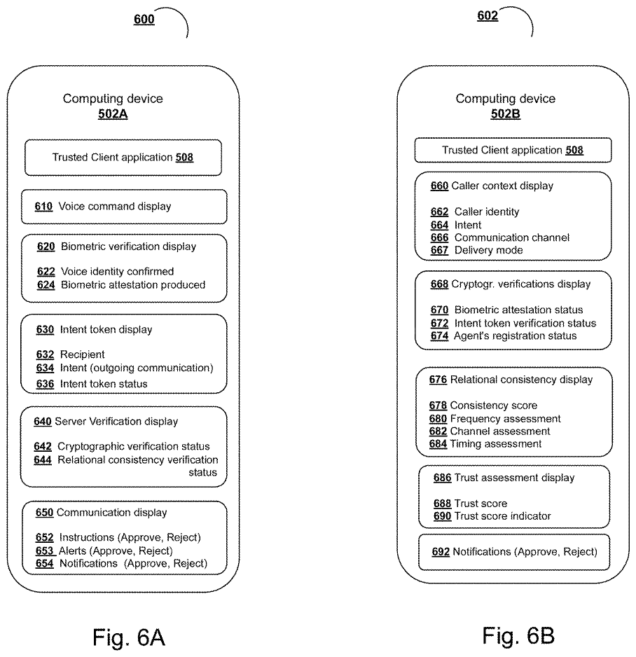

FIGS. 6A and 6B depict example user interfaces of trusted client application 508 displayed on a computing device 502, according to an embodiment of the invention.

FIG. 6A depicts an outbound interface 600 of trusted client application 508, displayed on a user interface of a computing device 502A of a user (i.e., a sender) during the process of authorizing an AI-mediated communication, according to an embodiment of the invention. The outbound authorization interface 600 provides the user with complete visibility into every step of the authorization sequence, enabling the user to understand what AI agent 520 has been authorized to do, to verify that computing device 502A correctly interpreted the voice command, and to intervene before the communication is initiated if anything is incorrect.

In an embodiment, the outbound authorization interface 600 may present the following information on the user interface during the authorization sequence:

A voice command display 610 may show a received voice command as interpreted by computing device 502. Voice command display 610 may enable the user to confirm that computing device 502A correctly captured the spoken instruction, including the intended recipient, the intent or the purpose of the communication, and any constraints on the agent's behavior. If computing device 502A misinterpreted the voice command, the user can cancel the authorization and re-issue the command before any communication is initiated, preventing AI agent 520 from acting on incorrect instructions.

A biometric verification display 620 may comprise a voice identity status indicator 622 showing whether the user's voice has been successfully matched against the registered voice biometric profile, and a biometric attestation indicator 624 showing whether the biometric authorization signal and the structured biometric attestation record have been generated. When biometric attestation indicator 624 shows that the biometric authorization signal and the structured biometric attestation record have been generated, biometric verification display 620 may provide the user with assurance that HSM 522 has received the biometric authorization signal and that the signing operation has been authorized. In the event of biometric verification failure for example, if computing device 502A does not recognize the speaker due to background noise, illness affecting the voice, or an unauthorized person attempting to issue a command, biometric verification display 620 shows a failure, and the authorization process halts at this point without generating a signed intent token.

An intent token display 630 may comprise the intended recipient 632 identifying the recipient user as parsed from the voice command, an intent 634 of the outgoing communication specifying the authorized purpose and scope of the communication as extracted by intent authorization engine 514, and an intent token status 636 indicating whether the intent token has been successfully constructed and signed by HSM 522. Intent token display 630 may enable the user to review the structured intent confirming that the correct recipient has been identified that the authorized operations accurately reflect what the user intends, and that any prohibited operations have been correctly captured. This review opportunity is particularly valuable when the voice command is complex or contains multiple constraints, as it allows the user to detect and correct misinterpretations before the transmission of signed intent token to centralized trust verification server 550.

A server verification display 640 may comprise a cryptographic verification status 642 showing the result of the cryptographic verification performed by cryptographic verification engine 554 at centralized trust verification server 550, and a relational consistency verification status 644 showing the result of the relational consistency verification performed by relationship verification engine 556. Server verification status 640 may provide the user with real-time feedback on whether centralized trust verification server 550 has cleared the communication. If cryptographic verification fails for example, because the agent's registration has been revoked or the skills hash does not match baseline 566, cryptographic verification status 642 may display the reason, alerting the user to a potential security issue with AI agent 520. If relational consistency verification fails for example, because the communication's timing, channel, or frequency is inconsistent with the established relationship pattern, relational consistency verification status 644 may display the specific dimensions that triggered the inconsistency, enabling the user to understand why the communication is flagged as unusual.

A communication display 650 may comprise instructions 652, alerts 653 and notifications 654 with approve and reject controls, which help the user to respond to instructions, alerts and notifications. In an embodiment, when relational consistency verification is unsuccessful, communication section 650 may present the notification received from centralized trust verification server 550 along with approve and reject controls, enabling the user to make an informed decision about whether to proceed with the communication despite the behavioral deviation or to terminate the communication. The approval and rejection controls may ensure that the user retains final authority over all AI-mediated communications, particularly those that deviate from established relationship patterns. This mechanism preserves the ability to initiate legitimate but unusual communications such as contacting a business colleague outside normal hours for an urgent matter while providing full transparency about why communication is flagged.

FIG. 6B depicts an inbound interface 602 of trusted client application 508, displayed on the user interface of computing device (for example, computing device 502B) of a recipient, according to an embodiment of the invention. The inbound verification interface 602 provides the recipient with comprehensive information about the incoming communication and verification status, enabling the recipient to make an informed decision about whether to accept or reject the communication based on the intent, cryptographic authorization, the relational consistency, and the behavioral characteristics of the incoming communication.

In an embodiment, the inbound verification interface 602 may present the following information to the recipient:

A caller context display 660 may show an incoming call including caller's identity 662 along with caller's AI agent, an intent 664 showing the purpose of the communication, an indicator for a communication channel 666 identifying the channel through which the communication is being transmitted (such as voice call, text message, electronic mail, or messaging platform communication), and an indicator for a delivery mode 667 showing a direct delivery or a screen delivery of the communication. In an embodiment, delivery mode 667 may display “direct delivery” when receiving verification node 532 has determined a direct delivery routing decision indicating the communication passed all verification checks with high consistency, or “screened delivery” when the communication requires the recipient's review before acceptance. Caller context display 660 may enable the recipient to see not only who is calling but also how they are reaching the recipient and what the caller's AI agent has been authorized to discuss, providing context.

In a particular embodiment, communication channel indicator 666 may be informative when viewed alongside channel assessment 682 in relational consistency display 676. For example, if channel assessment 682 shows “unusual” and communication channel 666 shows “voice call,” the recipient can immediately understand that this contact normally communicates via email but is currently attempting a voice call, which may indicate urgency or may warrant additional scrutiny. Intent 664 is extracted from the signed intent token and is therefore cryptographically verified, which may reflect that the human caller actually authorized the intent, not what the AI agent claims.

A cryptographic verification display 668 may comprise a biometric attestation status 670 confirming that the caller's biometric identity was verified at the time of authorization, an intent token verification status 672 confirming that the signed intent token carries a valid cryptographic signature from the caller's HSM, and an agent's registration status 674 confirming that the calling AI agent is currently registered with valid credentials and an unmodified instruction set. Cryptographic verification display 668 may provide the recipient with layered assurance about the authenticity of the incoming communication: the biometric attestation status 670 confirms a specific human authorized the communication, the intent token verification status 672 confirms the authorization has not been tampered with, and the agent registration status 674 confirms the AI agent has not been compromised through skill injection or other modification. Together, these three indicators give the recipient a level of trust verification that no existing communication system provides.

A relational consistency display 676 may comprise a consistency score 678 showing the overall multi-attribute behavioral consistency score computed by relationship verification engine 556, a frequency assessment 680 showing whether the communication frequency is consistent with the historical pattern of the relationship, a channel assessment 682 showing whether the communication channel is consistent with the historical channel preference of the relationship, and a timing assessment 684 showing whether the timing of the communication is consistent with the historical timing pattern of the relationship. Relational consistency display 676 may enable the recipient to see not just whether the communication was flagged as unusual, but specifically which behavioral dimensions caused the flag. For example, the recipient may see that the frequency and channel are normal, but the timing is unusual, indicating a late-night call from a contact who normally communicates during business hours, and can decide based on that specific context whether the call is likely urgent and worth accepting, or potentially suspicious and worth rejecting. This granular per-dimension visibility transforms the decision from a binary accept/reject with no context into an informed assessment based on specific behavioral evidence.

In an embodiment, inbound verification interface 602 may further present a trust assessment display 686 comprising a trust score 688 and the individual trust attribute scores generated by relationship verification engine 556 at centralized trust verification server 550. The trust assessment display 686 may present trust score 688 as an immediately visible numerical indicator on a scale of 0 to 100 along with a categorical label (for example, “TrustScore: 92 High” or “TrustScore: 45 Moderate”), enabling the recipient to form an immediate assessment of the communication's trustworthiness based on the depth and consistency of the established relationship. The individual trust attribute scores, including engagement rate, reliability index, channel preference score, temporal pattern score, and behavioral pattern score, may be available through progressive disclosure, where the recipient can access detailed attribute-level information by interacting with a trust score indicator 690. Trust assessment display 686, combined with cryptographic verification display 668 and relational consistency display 676, may provide the recipient with comprehensive, layered trust context encompassing cryptographic proof of human authorization, per-dimension behavioral consistency, and multi-attribute trust scoring, and enabling informed decision-making.

Notifications with approve/reject controls 692 may enable the recipient to accept or reject the incoming AI-mediated communication based on the information presented in inbound verification interface 602. Approve/reject controls 692 may further include an option to request additional information from the caller's AI agent before deciding, or to redirect the communication to a voicemail or messaging system for later review. Inbound verification interface 602 thereby empowers the recipient with complete control over which AI-mediated communications reach them, while providing the contextual verification information necessary to make that decision with confidence.

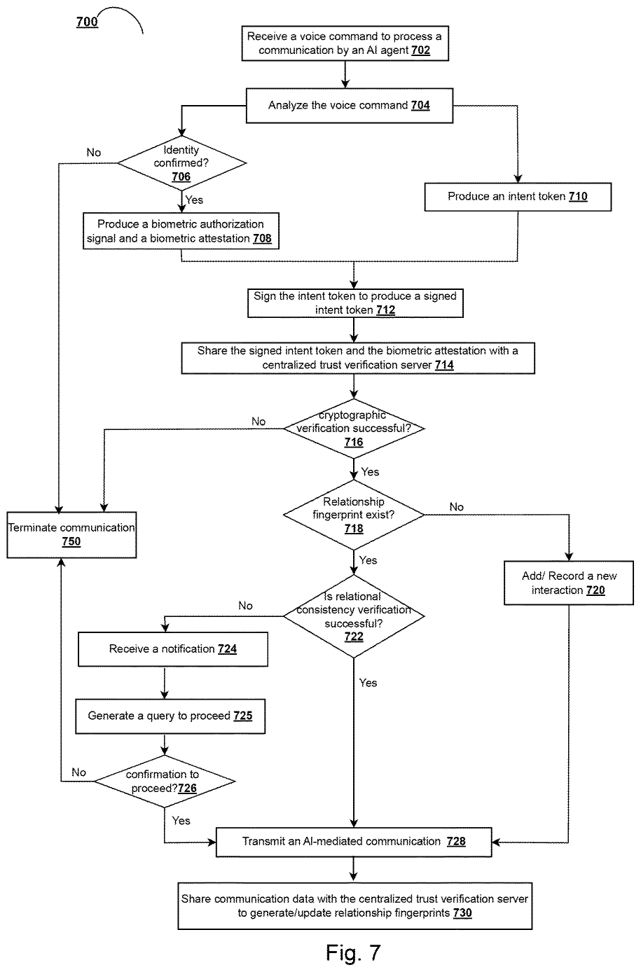

FIG. 7 is a flow diagram of an example method 700 for processing secure communications between autonomous AI agents of computing devices, according to an embodiment of the invention. The steps of method 700 may be performed at a computing device (for example, computing device 502A) of a user in conjunction with centralized trust verification server 550.

At step 702, computing device 502A may receive a voice command for AI agent 520 associated with computing device 502A to process communication. The voice command may be received through a microphone of the computing device 502A via biometric interface 524 without requiring the user to be in physical proximity, or to establish visual alignment with the computing device 502A. The user may be at any distance from the computing device 502A within microphone range. The voice command may specify the intended recipient, the purpose and authorized scope of the communication, the communication channel through which the communication is to be transmitted, and any constraints on the AI agent's behavior during the communication, including operations AI agent 520 is prohibited from performing. For example, the user may speak: “Have my agent call Dr. Smith's office to reschedule my Thursday appointment, but don't discuss my medical history.”

At step 704, biometric verification engine 510 may analyze the voice command for identity confirmation of the user based on a registered voice biometric profile of the user. The voice biometric profile may capture acoustic characteristics unique to the user, such as pitch, cadence, spectral features, and vocal tract resonance patterns. Biometric verification engine 510 may extract a voice biometric feature vector from the acoustic characteristics of the voice command and compute a matching score against the registered voice biometric profile. The voice biometric analysis occurs concurrently with the natural language processing of the voice command by intent authorization engine 514, such that identity verification and intent extraction are performed in parallel from the same voice input, minimizing latency.

In embodiments where voice command activation is unavailable or speaking a voice command is not possible for the user, the biometric verification may be performed using face recognition or fingerprint identification in place of the voice identification. In an embodiment, the biometric authorization signal may be produced by facial recognition or fingerprint identification through a biometric interface 524 of the operating system of computing device 502A. In an example, trusted client application 508 may receive a text command for AI agent 520 to process the communication. In response, biometric interface 524 may prompt the user for face recognition or fingerprints identification.

At step 706, biometric verification engine 510 may determine whether the identity of the user is confirmed. In an embodiment, when the matching score meets or exceeds a predetermined authentication threshold, identity of the user may be confirmed and method 700 may proceed to step 708. The predetermined authentication threshold may be configured by the system administrator or the user based on the desired balance between security and convenience, with higher thresholds providing stronger identity assurance and lower false acceptance rates. In an embodiment, when identity of the user is not confirmed for example, because the speaker is not the registered user, method 700 may terminate the communication at step 750, and the communication is not processed. The termination at step 750 ensures that no AI agent communication can be initiated without positive biometric confirmation of the specific human owner's identity.

At step 708, responsive to successful identity confirmation, biometric verification engine 510 may produce a biometric authorization signal that is transmitted internally within computing device 502A from biometric verification engine to HSM interface 512 confirming that the user's identity has been verified through biometric recognition. The biometric authorization signal is an internal, on-device signal, which authorizes the HSM 522 to perform the signing operation via HSM interface 512. In an embodiment, biometric verification engine 510 may produce a biometric attestation that is a substantive data artifact. The biometric attestation may comprise a structured data record including the biometric modality employed (voice biometric, facial recognition, or fingerprint recognition), a confidence score reflecting the strength of the biometric match against the registered profile, a timestamp of the biometric verification event, and a device attestation identifying the hardware platform on which the biometric verification was performed.

At step 710, intent authorization engine 514 may generate an intent token comprising an intent data structure based on the voice command. The intent data structure may comprise information of a recipient identifying the intended second user as parsed from the voice command, an intent of the communication specifying the purpose and authorized scope of the communication; metadata of the voice command including a timestamp and contextual information; a communication channel identifying the channel through which the communication is to be transmitted; an expiry timestamp after which the intent token is no longer valid, typically set to a period not exceeding ten minutes from the construction timestamp and a cryptographically random nonce ensuring uniqueness of the intent token and preventing replay attacks. In an embodiment, the intent data structure may further comprise a set of authorized communication operations specifying what the AI agent is permitted to perform while processing the communication and a set of prohibited communication operations specifying what the AI agent is explicitly prohibited from performing while processing the communication.

At step 712, upon receipt of the biometric authorization signal, HSM 522 may sign the intent token using the private key stored exclusively within HSM to produce a signed intent token. In an embodiment, HSM 522 performs the signing operation only upon receipt of the biometric authorization signal. In an embodiment, if the biometric authorization signal is not produced or received, HSM 522 may be precluded from performing the signing operation. In a certain embodiment, HSM 522 does not perform the signing operation without the biometric authorization signal. The resulting digital signature is mathematically bound to both the specific content of the intent token and the specific private key stored in HSM 522. Any modification to the intent token after signing may cause signature verification to fail. Any attempt to produce a valid signature without access to the hardware-stored private key is computationally infeasible.

At step 714, computing device 502A may share the signed intent token with centralized trust verification server 550 for cryptographic verification and relational consistency verification. In an embodiment, computing device 502A may also share the biometric attestation with centralized trust verification server 550 along with signed intent token. The signed intent token and biometric attestation may be transmitted over an encrypted channel maintained by secure connection manager 516. Centralized trust verification server 550 may receive the signed intent token and the biometric attestation and initiates the verification sequence.

At step 716, computing device 502A may determine whether the cryptographic verification is successful by receiving a result of the cryptographic verification from centralized trust verification server 550. Cryptographic verification engine 554 at centralized trust verification server 550 may perform the cryptographic verification, comprising a sequential series of verification steps as described in detail in conjunction with FIG. 8. The cryptographic verification steps are performed sequentially, with each step serving as a prerequisite gate for the subsequent step, such that failure at any step terminates the cryptographic verification process without performing the remaining steps. In an embodiment, when cryptographic verification is unsuccessful for example, because the agent's identity (agent's ID) is not registered, the agent's certificate has been revoked, the skills hash does not match baseline 566 recorded at AI agents'registry 560, the signature is invalid, the intent token has expired, the nonce has been previously processed, the intent violates the agent's policies, or the biometric attestation is invalid, centralized trust verification server 550 may transmit an instruction to terminate the communication to computing device 502A. On receipt of the termination instruction, computing device 502A may terminate method 700 at step 750, and the communication is not processed. The termination instruction may include a reason code identifying which verification step failed, enabling the user to understand and address the failure through the outbound authorization interface 600 of trusted client application 508. In an embodiment, when cryptographic verification is successful, method 700 proceeds to step 718. In an embodiment, computing device 502A may receive confirmation of successful cryptographic verification from centralized trust verification server 550 via trusted client application 508.

At step 718, method 700 may determine whether a relationship fingerprint exists for the user pair (the sender and the recipient pair) in relationship fingerprint database 582 within relationship repository 580 of centralized trust verification server 550. Relationship verification engine 556 may query relationship fingerprint database 582 using the identities of the sender and the intended recipient extracted from the signed intent token. In an embodiment, when a relationship fingerprint exists, it may indicate that the sender and the intended recipient have previously communicated and an accumulated behavioral model of their communication pattern has been established. Then, method 700 may proceed to relational consistency verification at step 722. In an embodiment, when no relationship fingerprint exists, indicating a first contact between the first user and the second user with no prior communication history, method 700 may proceed to step 720.

At step 720, when no relationship fingerprint exists for the first user and second user pair, relationship verification engine 556 may perform a first-contact relational consistency verification before transmitting a clearance instruction. The first-contact relational consistency verification may evaluate the recipient category, the communication channel, the user's stored preferences, any user-approved contact list, the permitted recipient categories and policies associated with AI agent 520, and the risk level of the requested intent. When the first-contact relational consistency verification is successful, relationship verification engine 556 may create an initial relationship fingerprint record in relationship fingerprint database 582, and method 700 may proceed to step 728. When the first-contact relational consistency verification is unsuccessful, centralized trust verification server 550 may require user confirmation or transmit a termination instruction.

At step 728, computing device 502A may receive a clearance instruction to process the communication from centralized trust verification server 550. Upon the receipt of clearance, AI agent 520 at computing device 502A may transmit the AI-mediated communication towards the recipient computing device 502B or the second user.

In an embodiment in which no relationship fingerprint exists for the first user and second user pair, relationship verification engine 556 performs a first-contact relational consistency verification before the clearance instruction is transmitted. The first-contact relational consistency verification may evaluate the recipient category, the communication channel, the user's stored preferences, any user-approved contact list, the permitted recipient categories and policies associated with AI agent 520, and the risk level of the requested intent. When the first-contact relational consistency verification satisfies the applicable policy, relationship verification engine 556 returns a successful relational consistency verification result and creates the initial relationship fingerprint record in relationship fingerprint database 582. When the first-contact relational consistency verification does not satisfy the applicable policy, centralized trust verification server 550 may require user confirmation or transmit a termination instruction.

At step 722, computing device 502A may determine whether relational consistency verification is successful by receiving a result of relational consistency verification from centralized trust verification server 550. Relationship verification engine 556 at centralized trust verification server 550 may perform the relational consistency verification, as described in detail in conjunction with FIG. 9. The relational consistency verification may comprise comparing the metadata of the intent data structure, including timing, communication channel, frequency, and topic against the behavioral model encoded in the relationship fingerprints for the first user and second user pair, and computing a multi-attribute behavioral consistency score from the comparison. In an embodiment, when the consistency score is high, such as 75 or greater, indicating the communication is consistent with the established behavioral pattern of the relationship, relational consistency verification is successful, and method 700 may proceed to step 728.

In an embodiment, when the consistency score is moderate, such as 50 to 74, or low, uch as below 50, relational consistency verification is unsuccessful at step 722. In an embodiment where the consistency score is low, indicating the communication is severely inconsistent with the established relationship, computing device 502A may receive from centralized trust verification server 550, a termination instruction, and method 700 may terminate at step 750. In an embodiment where the consistency score is moderate, indicating some behavioral deviation but not severe inconsistency, method 700 may proceed to step 724.

At step 724, computing device 502A may receive a notification in response to unsuccessful relational consistency verification. The notification may include the specific behavioral deviation that triggered the inconsistency, for example, that the timing is unusual for this relationship, or that the communication channel differs from the historical preference enabling the first user to understand why the system flagged the communication. The notification is presented through the communication section 650 of the outbound authorization interface 600 of trusted client application 508, including the approve/reject controls 654.

At step 725, upon receipt of the notification, trusted client application 508 may generate a query whether to proceed with processing the communication. By generating the query, trusted client application 508 provides an option to confirm or decline for the user. The user may approve to proceed with the communication or decline to abort the communication.

At step 726, trusted client application 508 may determine whether the first user confirms to proceed. The first user may review the notification including the specific behavioral deviations and make an informed decision. In an embodiment, when the first user confirms to proceed, indicating that the deviation may be intentional and the communication should proceed despite the behavioral inconsistency, method 700 may proceed to step 728. This mechanism preserves the ability to initiate legitimate but unusual communications, such as contacting a business colleague outside normal hours for an urgent matter or switching from email to a voice call for a time-sensitive discussion. In an embodiment, when the first user does not confirm, indicates that the deviation is unexpected and the communication should not proceed, method 700 may terminate at step 750, and the communication is not processed.

At step 728, responsive to successful cryptographic verification and relational consistency verification (or user's confirmation to proceed despite unsuccessful relational consistency verification), AI agent 520 may transmit an AI-mediated communication based on the intent data structure, along with the signed intent token and the biometric attestation, towards recipient computing device 502B through network 540. The signed intent token and biometric attestation are transmitted as structured header or metadata fields of the outgoing communication according to the communication channel specified in the intent data structure for example, as structured extension header fields within a SIP INVITE message for voice communications, as metadata fields accompanying a Rich Communication Services message for text communications, as abbreviated attestation references for legacy SMS communications with the full intent token retrievable from the centralized trust verification server 550, as additional header fields conforming to RFC 5322 for electronic mail communications, or as structured fields within an API request payload for third-party messaging platform communications. The AI-mediated communication is the actual content produced by AI agent 520 based on the intent data structure, that is the language, conversational responses, and interaction dynamics are generated by the AI agent acting on behalf of the user within the authorized scope specified in the signed intent token.

At step 730, after completing the communication, computing device 502A may share communication data with centralized trust verification server 550 to generate or update the relationship fingerprints based on the new record or an existing record for the first user and the second user pair. Communication data may comprise metadata of the completed communication including the timing, duration, channel, topic indicators, and interaction characteristics without requiring access to the communication content itself. Centralized trust verification server 550 may analyze communication data to determine communication patterns, including temporal patterns (timing, frequency, duration), channel preference patterns (voice, text, email), and behavioral patterns (response, behaviors, engagement levels). Based on the identified patterns, the centralized trust verification server generates or updates the relationship fingerprints in relationship fingerprint database 582. The relationship fingerprints continuously evolves as the relationship develops, becoming more sophisticated over time and making spoofing mathematically difficult since attackers cannot fabricate the complex pattern history that defines real relationships. Each communication contributes to the same unified relationship fingerprint record for the pair, regardless of whether the communication was initiated directly by the first user or by an AI agent acting on the first user's behalf.

FIG. 8 is a flow diagram of an example method 800 for performing cryptographic verification of step 716 of method 700 of FIG. 7 upon receiving the signed intent token at centralized trust verification server 550, according to an embodiment of the invention. Method 800 comprises multiple steps that are performed by cryptographic verification engine 554. The cryptographic verification steps may be performed sequentially, with each step serving as a prerequisite gate for the subsequent step, such that failure at any step may terminate the cryptographic verification process without performing the remaining steps.

At step 804, cryptographic verification engine 554 may verify the agent's ID against agents' IDs 562 stored in AI agents' registry 560 of centralized trust verification server 550. In an embodiment, cryptographic verification engine 554 extracts the agent's ID from the signed intent token and performs a lookup against agents' IDs 562 to confirm that the agent is currently registered, that the registration has not been revoked, and that the agent is associated with the claimed owner identity. This is a database lookup operation and is the fastest verification step. In an embodiment, if the agent is unregistered, has been revoked, or the owner identity does not match the registered owner, cryptographic verification may be unsuccessful at step 820. This step catches completely unregistered or decommissioned agents immediately before any further processing occurs.

At step 806, cryptographic verification engine 554 may verify the agent's certificate against agents' certificates 564 stored in AI agents' registry 560. The agent's certificate is a capability attestation record that was issued at the time of agent registration and attests to the agent's enumerated capabilities, restrictions, and the identity of the agent provider. Cryptographic verification engine 554 may confirm that the certificate was issued by centralized trust verification server 550, that the certificate has not expired, and that the certificate has not been revoked. In an embodiment, if the certificate is expired, revoked, or was not issued by centralized trust verification server 550, cryptographic verification may be unsuccessful at step 820.

At step 808, cryptographic verification engine 554 may determine whether the current cryptographic hash of the agent's installed instruction set matches the baseline hash stored in baselines 566 recorded in AI agents' registry 560. At the time the AI agent was registered with centralized trust verification server 550, a cryptographic hash of the agent's entire installed instruction set including every skill, every module, every instruction package was computed and stored as the baseline 566. The baseline 566 may correspond to the canonical agent manifest described above and may include code, tools, prompts, permissions, model identifiers, provider identifiers, and configuration files that can affect the communication behavior of AI agent 520 Cryptographic verification engine 554 may compare the current hash against this baseline. In an embodiment, if the hashes match, the agent's instruction set is unchanged since registration, indicating no skills have been added, removed, or modified. In an embodiment, if the hashes do not match, that may mean the agent's instruction set has been altered since registration, indicating a potential supply chain attack, a malicious skill injection, or an unauthorized modification to the agent's behavior. A hash mismatch immediately causes cryptographic verification to be unsuccessful at step 820 and invalidates the agent's registration. The agent may require re-registration before it may resume verified communications. This step is the primary defense against supply chain attacks and malicious skill injections and is placed before the more expensive signature verification step so that tampered agents are caught with minimal computational cost.

At step 810, cryptographic verification engine 554 may verify the cryptographic signature of the signed intent token using the first user's registered public key retrieved from public keys 570 stored in AI agents' registry 560. The public key corresponds to the private key stored exclusively within HSM 522 of the first user's computing device 502A. Cryptographic verification engine 554 may perform the mathematical signature validation, confirming that the intent token was signed by the specific private key corresponding to the registered public key and that the intent token has not been modified in any way since signing. This is the most computationally expensive verification step, involving public key cryptographic operations. It is placed after the less expensive checks so that the system avoids performing expensive cryptographic mathematics on communications that would have already been rejected by a registry lookup or hash comparison. In an embodiment, if the signature is invalid, indicating that the intent token was forged, was signed by a different key, or was modified after signing, the cryptographic verification may be unsuccessful at step 820.

At step 812, cryptographic verification engine 554 may verify that the expiry timestamp encoded in the signed intent token has not been exceeded. The expiry timestamp is typically set to a period not exceeding ten minutes from the construction timestamp, limiting the temporal validity of the authorization. This step is placed after signature verification because the expiry field is only meaningful after the signature proves that the signed intent token is authentic. There is no point checking whether a forged token has expired. In an embodiment, if the current time exceeds the expiry timestamp, the intent token may have expired, and the cryptographic verification may be unsuccessful at step 820. This feature prevents an attacker who somehow captures a valid signed intent token in transit from using it hours or days later.

At step 814, cryptographic verification engine 554 may verify that the nonce value encoded in the signed intent token has not been previously processed. Cryptographic verification engine 554 may maintain a record of previously processed nonces and check the current nonce against this record. In an embodiment, if the nonce has been previously processed, the intent token may be a replay i.e., a duplicate submission of a previously used authorization, and hence the cryptographic verification may be unsuccessful at step 820. The nonce, combined with the expiry timestamp, ensures that each intent token can be used exactly once within a limited time window. Even if a valid intent token has not yet expired, it cannot be submitted a second time because the nonce will be recognized as already processed.

In an embodiment in which both pre-initiation verification and pre-delivery verification are performed, cryptographic verification engine 554 may maintain a nonce state record that identifies a nonce as unused, pre-initiation verified, delivery verified, or expired. During pre-initiation verification, cryptographic verification engine 554 may change the nonce state from unused to pre-initiation verified without treating the nonce as replayed. During pre-delivery verification, receiving verification node 532 or centralized trust verification server 550 may verify that the nonce is in the pre-initiation verified state for the same signed intent token, sender, recipient, and expiry timestamp, and may then change the nonce state to delivery verified. A later attempt to use the same nonce after the nonce has been marked delivery verified may be rejected as a replay. In another embodiment, the intent data structure includes a first nonce for pre-initiation verification and a second nonce for pre-delivery verification, each of which is verified and consumed at its corresponding verification stage.

At step 816, cryptographic verification engine 554 may verify that the intent of the communication as encoded in the intent data structure falls within the policies 568 stored in AI agents' registry 560 associated with the registered agent. Policies 568 define the types of communications that AI agent 520 is authorized to initiate, the categories of recipients that AI agent 520 is authorized to contact, and any operational restrictions imposed on AI agent 520 at the time of registration. In an embodiment, if the intent of the communication violates any policy for example, AI agent 520 is attempting to initiate a type of communication that it is not authorized to perform, or AI agent 520 is attempting to contact a category of recipient it is restricted from contacting, the cryptographic verification may be unsuccessful at step 820.

At step 818, cryptographic verification engine 554 may verify the biometric attestation received alongside the signed intent token. Cryptographic verification engine 554 may confirm that the biometric modality recorded in the attestation is a recognized modality (voice biometric, facial recognition, or fingerprint recognition), that the confidence score meets or exceeds a minimum confidence threshold, that the timestamp of the biometric verification event is recent and consistent with the intent token construction timestamp (confirming that the biometric verification occurred at approximately the same time as the intent token was generated, not hours or days earlier), and that the device attestation identifies a recognized hardware platform. In an embodiment, if the biometric attestation is invalid, inconsistent, or stale, the cryptographic verification may be unsuccessful at step 820.

In an embodiment, when any of steps 804 through 818 fails, the cryptographic verification may be unsuccessful at step 820. Centralized trust verification server 550 may generate a termination instruction identifying the specific step that failed and transmit the termination instruction to computing device 502A. Method returns to step 716 of FIG. 7 with a result of unsuccessful cryptographic verification, which terminates the communication at step 750.

At step 824, when all of steps 804 through 818 pass, the cryptographic verification may be successful. Cryptographic verification engine 554 may generate a result of successful cryptographic verification, and the method returns to step 716 of FIG. 7 with the result of successful cryptographic verification. Then method 700 may proceed to the relationship fingerprint existence check at step 718.

In the embodiment described herein, the cryptographic verification steps of method 800 are presented in sequential ordering designed to evaluate the least computationally expensive checks first, such that the most common failure cases such as unregistered agents, revoked certificates, and tampered instruction sets are detected prior to performing the more computationally expensive cryptographic signature validation. However, one skilled in the art will appreciate that alternative orderings are within the scope of the invention. Steps 804, 806, and 808 are mutually independent and may be performed in any order or may be performed simultaneously as a batched query against AI agents' registry 560. Steps 812, 814, 816, and 818 are mutually independent of each other and may be performed in any order or simultaneously. In an embodiment, cryptographic verification engine 554 may resolve the agent identity at step 804 to retrieve the public key, and then perform the remaining steps in parallel across two processing paths: a first path performing signature verification at step 810 followed by intent field validation at steps 812 through 818, and a second path performing certificate validation at step 806 and hash comparison at step 808 concurrently with the first path. The prerequisite dependencies are as follows: step 810 depends on the resolution of the agent's identity at step 804 to retrieve the public key for signature validation; and steps 812, 814, 816, and 818 depend on step 810 in that the fields they examine within the intent token are only trustworthy after the signature confirms the integrity of the signed intent token. In alternative embodiments, steps 812 through 818 may be performed before signature verification as preliminary checks, with the understanding that their results are confirmed only after successful signature verification at step 810. Failure at any step, regardless of the order in which the steps are performed, results in unsuccessful cryptographic verification at step 820.

FIG. 9 is a flow diagram of an example method 900 for performing relational consistency verification, according to an embodiment of the invention. The steps of method 900 are performed by relationship verification engine 556 at centralized trust verification server 550, following successful cryptographic verification at step 716 and confirmation that a relationship fingerprint exists for the first user and second user pair at step 718 of method 700 of FIG. 7.

At step 902, relationship verification engine 556 may retrieve the relationship context for the first user and second user pair. The relationship context may be retrieved from interaction graph 586 stored in relationship repository 580 of centralized trust verification server 550. The interaction graph 586 maintains nodes representing registered users and devices, edges representing relationships, and communication history and patterns. The retrieved relationship context includes the full history of the communication relationship between the first user and the second user, including the accumulated behavioral model encoding how these specific users communicate, which may include their historical timing patterns, channel preferences, communication frequency, topic distribution, reciprocity, and behavioral pattern stability across all communication channels through which they have previously communicated.

At step 904, relationship verification engine 556 may extract the current metadata from the signed intent token. The current metadata may include the timing of the communication (the date, time of day, and day of week when the communication is being initiated), the communication channel (voice call, text message, electronic mail, or messaging platform), the communication frequency (how recently and how often the first user has communicated with this specific second user in the recent period), and the topic metadata (the subject matter of the communication as specified in the intent of the communication encoded in the intent data structure). The current metadata may further be supplemented by aggregated patterns stored in patterns database 584 within relationship repository 580, which provide cross-service pattern context that may be relevant to the evaluation.

At step 906, relationship verification engine 556 may compute a consistency score. The consistency score is a multi-attribute behavioral consistency score derived from a weighted function of multiple behavioral dimensions. For each behavioral dimension such as communication timing, communication channel, communication frequency, and communication topic, relationship verification engine 556 may compute a per-dimension deviation score reflecting the statistical distance between the current communication's metadata on that dimension and the historical baseline encoded in the relationship fingerprint for the user pair. For the timing dimension, the deviation score reflects how unusual the current time of communication is relative to the historical timing patterns for example, a call at 3 AM from a contact who historically communicates only during business hours would produce a high timing deviation score. For the channel dimension, the deviation score reflects how unusual the current channel is relative to the historical channel distribution for example, a voice call from a contact who historically communicates exclusively by email would produce a high channel deviation score. For the frequency dimension, the deviation score reflects how unusual the current rate of communication is relative to the historical frequency pattern for example, five calls in one day from a contact who historically communicates once per month would produce a high frequency deviation score. For the topic dimension, the deviation score reflects how unusual the declared topic is relative to the historical topic distribution for example, a communication about financial matters from a contact with whom the first user has historically discussed only project scheduling would produce a high topic deviation score.

Each per-dimension deviation score may be evaluated against a per-dimension anomaly threshold. When a per-dimension deviation score exceeds its anomaly threshold, that dimension may be flagged as anomalous. The per-dimension deviation scores may then be combined through a weighted aggregation function to produce the final multi-attribute behavioral consistency score. The weighting function may assign amplified weight to any dimension flagged as anomalous, such that a severe deviation on any single dimension may prevent the overall consistency score from remaining high even if the remaining dimensions are within normal ranges. This ensures that a compromised agent that mimics normal patterns on three dimensions but deviates severely on one dimension for example, contacting the correct person at the correct time by the correct channel but on a completely unauthorized topic is detected by the scoring function.

In an embodiment, each per-dimension deviation score is normalized to a value between 0 and 1, where 0 represents no deviation from the relationship fingerprint and 1 represents maximum deviation. Relationship verification engine 556 may compute a normalized deviation value D according to: D=min(1, (wtiming×dtiming)+(wchannel×dchannel)+(wfrequency×dfrequency)+(wtopic×dtopic)+Aanomaly), where wtiming, wchannel, wfrequency, and wtopic are weighting values that sum to 1.0, dtiming, dchannel, dfrequency, and dtopic are the normalized per-dimension deviation scores, and Aanomaly is an additional anomaly penalty applied when one or more per-dimension anomaly thresholds are exceeded. Relationship verification engine 556 may compute the multi-attribute behavioral consistency score as 100×(1−D). A score of 75 or greater may be classified as high, a score of 50 to 74 may be classified as moderate, and a score below 50 may be classified as low. The weighting values, anomaly penalty, and threshold values may be adjusted based on the user's preferences, enterprise policy, deployment security posture, communication channel, or relationship maturity.

At step 908, relationship verification engine 556 may evaluate the consistency score to determine a consistency score level. In an embodiment, when the consistency score is high, such as 75 or greater, indicating the communication is consistent with the established behavioral pattern of the relationship across all dimensions and no individual dimension is flagged as anomalous, method 900 may proceed to step 914 where centralized trust verification server 550 may transmit a clearance instruction to proceed with the communication to computing device 502A. At step 914, relational consistency verification is successful, and method returns to step 722 of FIG. 7 with a successful result, proceeding to transmit the AI-mediated communication at step 728.

In another embodiment, when the consistency score is low, such as below 50, indicating the communication is severely inconsistent with the established relationship, with multiple dimensions flagged as anomalous or a single dimension showing extreme deviation, method 900 may proceed to step 910, where centralized trust verification server 550 sends a termination instruction to computing device 502A. The communication is terminated at step 750 of FIG. 7 without querying the first user. This catches the most obvious cases of a compromised agent acting wildly outside the relationship's normal behavioral boundaries, where the deviation is so severe that no legitimate explanation is plausible.

In another embodiment, when the consistency score is moderate, such as 50 to 74, indicating some behavioral deviation from the established pattern such as an unusual timing or an atypical channel, but not a severe inconsistency, method 900 may proceed to step 912 where centralized trust verification server 550 may transmit a notification to computing device 502A. Upon receiving the notification, computing device 502A may generate a query for the first user whether to proceed with the communication. The notification may include the specific dimensions that triggered the deviation and the degree of deviation on each dimension, enabling the first user to make an informed decision. Method returns to step 722 of FIG. 7 with an unsuccessful result, which then proceeds to step 724 where the first user may receive the notification followed by a query at step 725. The first user may confirm to proceed or decline at step 726.

FIG. 10 is a flow diagram of an example method 1000 for routing AI-mediated communications at a receiving verification node, according to an embodiment of the invention. Method 1000 is performed by receiving verification node 532 operating at network infrastructure 530 between the communication channel and the recipient's computing device, after the AI-mediated communication has been transmitted at step 728 of method 700. Receiving verification node 532 is a software component or module deployed at a network infrastructure point through which the communication passes prior to delivery to the recipient. Receiving verification node 532 may be implemented as a software module integrated into a carrier's Session Initiation Protocol (SIP) routing infrastructure for voice communications, as a processing plugin within a mail transfer agent for electronic mail communications, or as an application programming interface integration within a third-party messaging platform's delivery pipeline, in a manner analogous to the integration of STIR/SHAKEN attestation verification into existing carrier call routing workflows.

At step 1002, receiving verification node 532 may receive the AI-mediated communication transmitted from AI agent 520 as described in step 728 of method 700 of FIG. 7.

At step 1004, receiving verification node 532 may extract the signed intent token and the biometric attestation from the structured header or metadata fields of the received communication for example, from the SIP INVITE headers for voice communications, from the RCS metadata or abbreviated attestation reference for text communications, from the RFC 5322 headers for electronic mail communications, or from the API request payload for third-party platform communications.

At step 1006, receiving verification node 532 may perform the cryptographic verification of the signed intent token. The cryptographic verification at receiving verification node 532 may comprise a subset of the full verification performed by cryptographic verification engine 554 at centralized trust verification server 550 as described in FIG. 8, or may comprise the full verification sequence. At minimum, receiving verification node 532 may verify the cryptographic signature using the first user's registered public key, verify that the expiry timestamp has not been exceeded, and verify that the nonce is in a valid state for pre-delivery verification, or verify a separate pre-delivery nonce, confirming that the signed intent token is authentic, unexpired, and not replayed. Receiving verification node 532 may query centralized trust verification server 550 for the public key and additional verification data or maintain a local cache of frequently accessed verification data.

At step 1008, receiving verification node 532 may determine whether cryptographic verification is successful. When cryptographic verification is successful, it indicates that the signed intent token is valid. When cryptographic verification is unsuccessful, it indicates that the signed intent token is invalid, expired, replayed, or forged.

At step 1010, receiving verification node 532 may perform the relational consistency verification and compute the trust score for trust determination. Receiving verification node 532 may evaluate the communication's behavioral metadata against the relationship fingerprints for the first user and second user pair stored in relationship fingerprint database 582, using the same multi-attribute behavioral comparison performed by relationship verification engine 556 as described in context of FIG. 9. Receiving verification node 532 may further compute the individual trust attribute scores comprising engagement rate, reliability index, channel preference score, temporal pattern score, and behavioral pattern score from the relationship fingerprint for the pair of users, and may generate the trust score by combining the normalized individual trust attribute scores through the weighted aggregation function described in conjunction with FIG. 5.

At step 1012, receiving verification node 532 may determine whether the trust score is high, moderate or low. Receiving verification node 532 may further determine a routing decision based on a trust state of the AI-mediated communication based on a combined evaluation of two independent verifications: the result of the cryptographic verification of the signed intent token performed at step 1006, and the trust score computed at step 1010.

When the cryptographic verification is successful and the trust score is high, for example in the range of 75 to 100, indicating that the communication was authorized by a voice-biometric-verified user and the relationship reflects deep, established behavioral history, the trust state is a first trust state 1014. In first trust state 1014, the routing decision may be a direct delivery 1016. Accordingly, AI-mediated communication may be routed directly to the recipient's computing device 502B without screening.

In a second trust state 1018, when the cryptographic verification is successful and the trust score is moderate for example, in the range of 50 to 74, indicating that the communication was authorized by a voice-biometric-verified user but the relationship is new or insufficiently established to route without context, the routing decision may be a screened delivery 1020. In this state, the trust score along with the individual trust attribute scores may be presented to the recipient through the inbound verification interface 602 of trusted client application 508 on the recipient's computing device 502B, enabling the recipient to make an informed decision about whether to accept the communication. In second trust state 1018, the AI agent of the recipient may intercept the communication to provide context to the recipient before connection.

In a third trust state 1022, when the cryptographic verification is unsuccessful or absent and the trust score is high, for example in the range of 75 to 100, the routing decision may be a block delivery with a notification 1024 to sender computing device 502A regardless of the high trust score. Although the behavioral characteristics of the communication are consistent with a deep established relationship, the absence of biometric-authenticated cryptographic authorization indicates that the communication may not be authorized by the registered user. This condition is consistent with a compromised legitimate agent exploiting the authentic behavioral patterns of the relationship to appear consistent while operating without the registered owner's authorization. The AI-mediated communication may be blocked at network infrastructure 530. Further, centralized trust verification server 550 may transmit a notification to trusted client application 508 on sender computing device 502A indicating that the AI-mediated communication originating from registered AI agent 520 is blocked because it lacks biometric-authenticated cryptographic authorization. This notification may enable the registered user of sender computing device 502A to become aware that the communication was transmitted without the biometric authorization, which may indicate that AI agent has been compromised. The recipient may be separately notified by receiving verification node 532 that a communication exhibiting relationship-consistent behavioral patterns is blocked because it lacks biometric-authenticated cryptographic authorization.

In a fourth trust state 1026, when the cryptographic verification is unsuccessful or absent and the trust score is moderate or low, for example below 75, or no relationship fingerprint exists for the pair of users in relationship fingerprint database 582, the routing decision may be a block delivery 1028, and the AI-mediated communication may be blocked at network infrastructure 530 before delivery to the recipient's computing device 502B. That is, the AI-mediated communication may not be delivered to the recipient's computing device 502B.

In a fourth trust state 1026, when the cryptographic verification is unsuccessful or absent and the trust score is moderate or low, for example below 75, or no relationship fingerprint exists for the pair of users in relationship fingerprint database 582, the routing decision may be a block delivery 1028, and the AI-mediated communication may be blocked at network infrastructure 530 before delivery to the recipient's computing device 502B.

The threshold ranges, described herein, represent example threshold ranges and may be adjusted to reflect different security postures as described herein. Regardless of the specific threshold values configured, the non-substitutability principle remains invariant. The trust score, regardless of being high, cannot override the requirement for the successful cryptographic verification of the signed intent token for a communication to qualify for the first trust state and receive direct delivery.

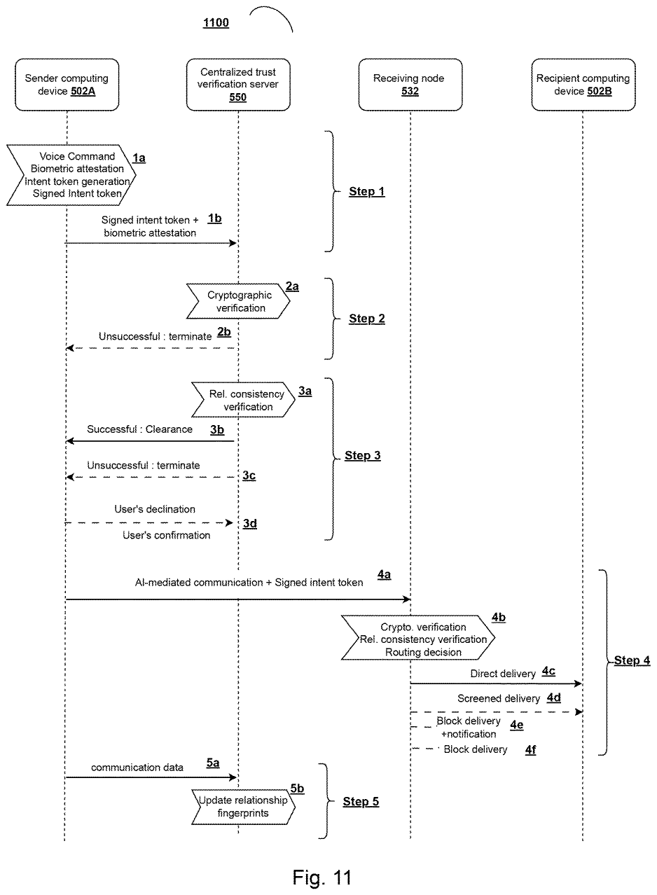

FIG. 11 is an interaction sequence diagram 1100 illustrating the temporal flow of messages and data between the sender computing device 502A, the centralized trust verification server 550, the receiving verification node 532 at the network infrastructure 530, and the recipient computing device 502B, during a secure AI agent communication session, according to an embodiment of the invention. The interaction sequence diagram shows the numbered steps in chronological order as the communication progresses from the initial voice command through verification, transmission, receiving-side routing, and post-communication fingerprint update.

At Step 1, sender computing device 502A may perform local processing, at step 1a, comprising receiving the voice command, performing biometric verification to produce the biometric authorization signal and biometric attestation, generating the intent token through intent authorization engine 514, and signing the intent token through HSM 522 to produce the signed intent token. Computing device 502A may then transmit the signed intent token and the biometric attestation to centralized trust verification server 550 through secure connection manager 516 at step 1b.

At Step 2, centralized trust verification server 550 may perform, at step 2a, the cryptographic verification through cryptographic verification engine 554 as described in FIG. 8. In an embodiment, when the cryptographic verification is unsuccessful, centralized trust verification server 550, at step 2b, may transmit a termination instruction to sender's computing device 502A and the communication process ends. In an embodiment, when the cryptographic verification is successful, centralized trust verification server 550 may send a result of successful cryptographic verification to sender's computing device 502A and proceed to perform the relational consistency verification.

At Step 3, centralized trust verification server 550, at step 3a, may perform the relational consistency verification through relationship verification engine 556 as described in FIG. 9, and transmit the verification result to sender computing device 502A. When relational consistency verification is successful (high consistency score), server 550, at step 3b, may transmit a clearance instruction to proceed. When the relational consistency verification is unsuccessful with a moderate consistency score, the server 550, at step 3c, may transmit an alert or a notification to computing device 502A including the specific behavioral deviations detected. The user reviews the notification through the outbound authorization interface 600 and may provide, at step 3d, confirmation to proceed or may decline, in which case the communication is terminated. When the consistency score is low, such as below 50, the server 550, at step 3c, may transmit the termination instruction to computing device 502A.

At Step 4, upon receiving the clearance instruction or the first user's confirmation to proceed, AI agent 520 on sender's computing device 502A, at step 4a, may transmit the AI-mediated communication along with the signed intent token and the biometric attestation through network 540 toward recipient's computing device 502B. The AI-mediated communication travels through the network infrastructure 530 where it may be analyzed by receiving verification node 532 before reaching recipient's computing device 502B. At step 4b, receiving verification node 532 at the network infrastructure 530 may perform its own verification of the incoming AI-mediated communication as described in FIG. 10. Receiving verification node 532 may perform the cryptographic verification, the relational consistency verification, compute the trust score, and determine the trust state and the routing decision. Based on the routing decision, the AI-mediated communication may be either directly delivered (first trust state 1014), at step 4c, to recipient's computing device 502B, delivered, at step 4d, through a screened delivery (second trust state 1018) to recipient's computing device 502B, blocked and a notification may be sent to sender's computing device 502A (third trust state 1022) at step 4e or blocked (fourth trust state 1026) at step 4f.

After completing the communication, at Step 5, sender computing device 502A may share communication data with centralized trust verification server 550, at step 5a. On receiving the communication data, server 550, at step 5b, may update the relationship fingerprints in relationship fingerprint database 582, ensuring that the relationship fingerprint evolves with each interaction.

### Embodiments

In a first example, a registered user, Alice, is at home and wishes her AI agent to call her doctor's office to reschedule an appointment. Alice speaks: “Have my agent call Dr. Patel's office to reschedule my Thursday appointment, but don't discuss my medical history.” Alice's smartphone receives the voice command through its microphone. Biometric verification engine 510 compares Alice's voice against her registered voice biometric profile and confirms her identity. Intent authorization engine 514 generates an intent token specifying the recipient as Dr. Patel's office, authorized operations as appointment scheduling, and prohibited operations as medical history disclosure. HSM 522 signs the intent token upon receipt of the biometric confirmation. The signed token is transmitted to centralized trust verification server 550. Cryptographic verification engine 554 verifies the signature, confirms that the token has not expired, and checks the nonce. Relationship verification engine 556 confirms that Alice has an established relationship fingerprint with Dr. Patel's office reflecting regular appointment-related calls. The relational consistency verification is successful. AI agent 520 is then cleared to initiate the call and hence transmits the AI-mediated communication.

In a second example, a registered user, Bob, is working at his Windows PC and instructs his AI agent through the trusted client application PWA running in his browser to send an email to a new vendor he has never contacted before. Bob speaks the voice command. His Windows PC's microphone captures the command. Biometric verification engine 510 confirms Bob's identity through voice biometric. Intent authorization engine 514 generates the intent token. HSM interface 512 accesses the Trusted Platform Module through the WebAuthn API in the browser. The TPM signs the intent token upon biometric confirmation through Windows Hello. The signed token is transmitted to centralized trust verification server 550. Cryptographic verification succeeds. Relationship verification engine 556 finds no existing relationship fingerprint for Bob and this vendor. The system records a new interaction and creates a new relationship fingerprint record for the pair. Because this is a first contact with valid cryptographic authorization, the AI-mediated communication proceeds. Subsequent communication between Bob and this vendor, whether initiated by Bob directly or by his AI agent, contribute to the same unified relationship fingerprint.

In a third example, a registered user, Carol, receives an incoming AI-mediated communication from Dave's registered AI agent. The communication arrives at receiving verification node 532 at Carol's carrier's SIP routing infrastructure. Receiving verification node 532 extracts the signed intent token from the SIP headers and queries centralized trust verification server 550. Cryptographic verification succeeds in indicating Dave's token is valid. However, the relational consistency score is moderate, indicating Dave normally contacts Carol during business hours via email, but this is a voice call at 10 PM. Receiving verification node 532 determines a screened delivery routing decision. Carol's trusted client application presents the call through the Communications Assistant interface, displaying verified AI agent of Dave, cryptographic authorization confirmed, but unusual timing and channel for this relationship. Carol can choose to accept or reject the call with full context.

In a fourth example, a compromised AI agent attempts to initiate communication using credentials belonging to its legitimate owner, Eve. The compromised agent has been infected through a malicious skill injection. However, the malicious skill installation has changed the cryptographic hash of the agent's instruction set. When the signed intent token reaches centralized trust verification server 550, cryptographic verification engine 554 detects that the skills hash in the agent's registry record does not match the current hash. The capability attestation record is invalidated. Cryptographic verification fails. Centralized trust verification server 550 transmits an instruction to terminate communication. The compromised agent is blocked before any AI-mediated communication is transmitted. Eve receives a notification that her agent's instruction set has been modified and that re-registration is required.

The skilled person will be aware of a range of possible modifications of the various embodiments described above. Accordingly, the present invention is defined by the claims and their equivalents.

What is claimed is:

1. A system for secure communication between autonomous artificial intelligence (AI) agents, the system comprising:
a computing device comprising one or more processors, a memory, and a plurality of programming instructions stored in the memory, the plurality of programming instructions when executed by the one or more processors causes the one or more processors to:
receive, at a trusted client application, a voice command from a user of the computing device for an AI agent associated with the computing device to process a communication to be transmitted towards a recipient computing device, wherein the communication is one of a voice message, an audio call, a text message, an email or a video communication;
analyze, at a biometric verification engine of the trusted client application, the voice command for identity confirmation of the user based on a registered voice biometric profile of the user;
responsive to successful identity confirmation, produce, at the biometric verification engine, a biometric authorization signal and a biometric attestation;
generate, at an intent authorization engine of the trusted client application, an intent token comprising an intent data structure based on the voice command, wherein the intent data structure comprises information of a user of the recipient computing device, an intent of the communication, metadata of the voice command, an expiry timestamp, and a nonce;
upon receipt of the biometric authorization signal, perform, at a hardware security module, a signing operation of the intent token using a private key to produce a signed intent token, wherein the private key is generated and stored within the hardware security module, and is inaccessible to a software process, operating system, application, or AI agent running on the computing device or on a remote system;
share, by the trusted client application, the signed intent token and the biometric attestation with a centralized trust verification server for cryptographic verification and relational consistency verification based on the intent of the communication; and
responsive to successful cryptographic verification and relational consistency verification, transmit, by the AI agent, an AI-mediated communication based on the intent data structure towards the recipient computing device.

2. The system of claim 1, wherein the plurality of programming instructions when executed by the one or more processors causes the one or more processors to:
register, by the trusted client application, the AI agent with the centralized trust verification server before processing the communication.

3. The system of claim 2, wherein the plurality of programming instructions when executed by the one or more processors causes the one or more processors to:
compute, by the trusted client application, a cryptographic hash of an installed instruction set of the AI agent; and
transmit, by the trusted client application, the cryptographic hash to the centralized trust verification server.

4. The system of claim 1, wherein the plurality of programming instructions when executed by the one or more processors causes the one or more processors to:
compare acoustic characteristics of the voice command against a registered voice biometric profile of the user for the identity confirmation.

5. The system of claim 1, wherein the intent data structure further comprises:
a set of authorized communication operations comprising operations, functions, or types of communications that the AI agent is permitted to perform while processing the communication; and
a set of prohibited communication operations comprising operations, functions, or types of communications that the AI agent is prohibited from performing while processing the communication.

6. The system of claim 1, wherein the plurality of programming instructions when executed by the one or more processors causes the one or more processors to:
preclude the hardware security module from performing the signing operation of the intent token absent the biometric authorization signal.

7. The system of claim 1, wherein the plurality of programming instructions when executed by the one or more processors causes the one or more processors to:
responsive to an unsuccessful cryptographic verification, receive, from the centralized trust verification server, a termination instruction to abort the communication.

8. The system of claim 1, wherein the plurality of programming instructions when executed by the one or more processors causes the one or more processors to:
responsive to an unsuccessful relational consistency verification associated with a moderate behavioral consistency score, receive, from the centralized trust verification server, a notification including one or more behavioral dimensions of the communication that deviate from established patterns encoded in relationship fingerprints;
generate, by the trusted client application, a query whether to proceed with the communication for the user; and
upon receipt of a confirmation to proceed from the user, transmit, by the AI agent, the AI-mediated communication.

9. The system of claim 1, wherein the plurality of programming instructions when executed by the one or more processors causes the one or more processors to:
transmit, by the AI agent, the AI-mediated communication along with the signed intent token and the biometric attestation as structured fields within a communication protocol message.

10. A computer-implemented method for secure communications between autonomous artificial intelligence (AI) agents of computing devices, the method comprising:
receiving, at a trusted client application, a voice command from a user of the computing device for an AI agent associated with the computing device to process a communication to be transmitted towards a recipient computing device, wherein the communication is one of a voice message, an audio call, a text message, an email or a video communication;
analyzing, at a biometric verification engine of the trusted client application, the voice command for identity confirmation of the user based on a registered voice biometric profile of the user;
responsive to successful identity confirmation, producing, at the biometric verification engine, a biometric authorization signal and a biometric attestation;
generating, at an intent authorization engine of the trusted client application, an intent token comprising an intent data structure based on the voice command, wherein the intent data structure comprises information of a user of the recipient computing device, an intent of the communication, metadata of the voice command, an expiry timestamp, and a nonce;
upon receipt of the biometric authorization signal, performing, at a hardware security module, a signing operation of the intent token using a private key to produce a signed intent token, wherein the private key is generated and stored within the hardware security module, and is inaccessible to any software process, operating system, application, or AI agent running on the computing device or on a remote system;
sharing, by the trusted client application, the signed intent token and the biometric attestation with a centralized trust verification server for cryptographic verification and relational consistency verification based on the intent of the communication; and
responsive to successful cryptographic verification and relational consistency verification, transmitting, by the AI agent, an AI-mediated communication based on the intent data structure towards the recipient computing device.

11. The method of claim 10, further comprising registering, by the trusted client application, the AI agent with the centralized trust verification server before processing the communication.

12. The method of claim 11, further comprising:
computing, by the trusted client application, a cryptographic hash of an installed instruction set of the AI agent; and
transmitting, by the trusted client application, the cryptographic hash to the centralized trust verification server.

13. The method of claim 10, further comprising comparing acoustic characteristics of the voice command against a registered voice biometric profile of the user for the identity confirmation.

14. The method of claim 10, wherein the intent data structure further comprises:
a set of authorized communication operations comprising operations, functions, or types of communications that the AI agent is permitted to perform while processing the communication; and
a set of prohibited communication operations comprising operations, functions, or types of communications that the AI agent is prohibited from performing while processing the communication.

15. The method of claim 10, further comprising:
precluding the hardware security module from performing the signing operation of the intent token absent the biometric authorization signal.

16. The method of claim 10, further comprising:
responsive to an unsuccessful cryptographic verification, receiving, from the centralized trust verification server, a termination instruction to abort the communication.

17. The method of claim 10, further comprising:
responsive to an unsuccessful relational consistency verification associated with a moderate behavioral consistency score, receiving, from the centralized trust verification server, a notification including one or more behavioral dimensions of the communication that deviate from established patterns encoded in relationship fingerprints;
generating, by the trusted client application, a query whether to proceed with the communication, for the user; and
upon receipt of a confirmation to proceed from the user, transmitting, by the AI agent, the AI-mediated communication.

18. The method of claim 10, further comprising:
before delivering the AI-mediated communication to the recipient, routing, by a network infrastructure, the AI-mediated communication based on a routing decision determined by a receiving verification node operating at the network infrastructure, based on a cryptographic verification and a relational consistency verification performed by the receiving verification node.

19. The method of claim 18, wherein the routing decision comprises a direct delivery, a screened delivery or a block delivery of the AI-mediated communication to the recipient computing device.

20. The method of claim 10, further comprising:
transmitting, by the AI agent, the AI-mediated communication along with the signed intent token and the biometric attestation as structured fields within a communication protocol message.

21. A system for secure communications between autonomous artificial intelligence (AI) agents, the system comprising:
a computing device comprising one or more processors, a memory, and a plurality of programming instructions stored in the memory, the plurality of programming instructions when executed by the one or more processors causes the one or more processors to:
receive a voice command, at a microphone, from a user of the computing device for an AI agent associated with the computing device to process a communication to be transmitted towards a recipient computing device, wherein the communication is one of a voice message, an audio call, a text message, an email or a video communication;
analyze, at a biometric verification engine of a trusted client application, the voice command for identity confirmation of the user based on a registered voice biometric profile of the user;
responsive to successful identity confirmation, produce, at the biometric verification engine, a biometric authorization signal and a biometric attestation;
generate, at an intent authorization engine of the trusted client application, an intent token comprising an intent data structure based on the voice command, wherein the intent data structure comprises information of a user of the recipient computing device, an intent of the communication, metadata of the voice command, an expiry timestamp, and a nonce;
upon receipt of the biometric authorization signal, perform, at a hardware security module, a signing operation of the intent token using a private key to produce a signed intent token, wherein the private key is generated and stored within the hardware security module, and is inaccessible to a software process, operating system, application, or AI agent running on the computing device or on a remote system;
share, by the trusted client application, the signed intent token and the biometric attestation with a centralized trust verification server for cryptographic verification and relational consistency verification based on the intent of the communication; and
responsive to successful cryptographic verification and relational consistency verification, transmit, by the AI agent, an AI-mediated communication based on the intent data structure along with the signed intent token and the biometric attestation as structured fields within a communication protocol message towards the recipient computing device; and
a receiving verification node operating at a network infrastructure between the computing device and the recipient computing device, the receiving verification node is configured to:
receive the transmitted AI-mediated communication to be delivered to the recipient computing device;
extract the signed intent token and the biometric attestation from the received AI-mediated communication;
compute a routing decision by performing a cryptographic verification and a relational consistency verification of the received AI-mediated communication; and
route, by the network infrastructure, the AI-mediated communication based on the routing decision.

22. The system of claim 21, wherein the routing decision comprises a direct delivery, a screened delivery or a block delivery of the AI-mediated communication to the recipient computing device.
